(19) United States
(12) Patent Application Publication
(10) Pub. No.: US 2024/0329931 A1
(43) Pub. Date: Oct. 3, 2024

(54) Signal Processing Method And Signal Processing Device

(71) Applicant: SEIKO EPSON CORPORATION, Tokyo (JP)

(72) Inventor: Masayoshi TODOROKIHARA, Suwa (JP)

(21) Appl. No.: 18/617,685

(22) Filed: Mar. 27, 2024

(30) Foreign Application Priority Data
Mar. 28, 2023 (JP) 2023-051113

(51) Int. Cl. G06F 7/523; G06F 1/12; G06F 7/50

(52) U.S. Cl. CPC G06F 7/523; G06F 1/12; G06F 7/50

(57) ABSTRACT

A signal processing method includes: an analysis object data generation step of generating i-th analysis object data based on time-series data of a physical quantity detected by an i-th sensor; a product-sum operation step of generating product-sum operation data of template data including a signal component to be analyzed and M-th analysis object data; and a synchronous-timing detection step of detecting a synchronous timing, which is timing synchronizing with the signal component, based on the product-sum operation data. The template data is shorter than the M-th analysis object data, and a sampling rate of the M-th analysis object data is equal to a sampling rate of the template data.

The present application is based on, and claims priority from JP Application Serial Number 2023-051113, filed Mar. 28, 2023, the disclosure of which is hereby incorporated by reference herein in its entirety.

### BACKGROUND

### 1. Technical Field

The present disclosure relates to a signal processing method and a signal processing device.

### 2. Related Art

In the related art, in a vibration diagnosis of a rotating machine, when a diagnosis using rotation phase information is to be performed, a vibration time waveform and a rotation pulse signal are obtained from the rotating machine, a vibration waveform component synchronizing with the rotation pulse signal is extracted, and the diagnosis is performed. For example, “API Standard 670: Machinery Protection Systems (fifth edition, published in November 2014)” discloses a method and a procedure for performing a target diagnosis by obtaining a vibration time waveform or an orbit diagram with a rotation pulse serving as an absolute reference, extracting a vibration waveform component synchronized with the rotation pulse to obtain a full spectrum, and the like.

API Standard 670. Machinery Protection Systems. FIFTH EDITION, November 2014 is an example of the related art.

In the method disclosed in API Standard 670, when the signal component to be analyzed is not synchronized with the rotation pulse signal, the signal component is reduced.

### SUMMARY

A signal processing method according to an aspect includes:
an analysis object data generation step of generating, for each integer i of 1 or more and N or less, i-th analysis object data based on time-series data of a physical quantity detected by an i-th sensor provided in an object to be analyzed, N being a predetermined integer of 1 or more;
a product-sum operation step of generating product-sum operation data by performing a plurality of times of product-sum operation processing on template data and M-th analysis object data while shifting a phase of at least one of the template data and the M-th analysis object data, M being an integer of 1 or more and N or less, and the template data being time-series data including a signal component to be analyzed; and
a synchronous-timing detection step of detecting a synchronous timing, which is a timing synchronizing with the signal component to be analyzed, with respect to the first to N-th analysis object data based on the product-sum operation data, in which
the template data is shorter than the M-th analysis object data, and
a sampling rate of the M-th analysis object data is equal to a sampling rate of the template data.

A signal processing device according to an aspect includes:
an analysis object data generation circuit configured to generate, for each integer i of 1 or more and N or less, i-th analysis object data based on time-series data of a physical quantity detected by an i-th sensor provided in an object to be analyzed, N being a predetermined integer of 1 or more;
a product-sum operation circuit configured to generate product-sum operation data by performing a plurality of times of product-sum operation processing on template data and M-th analysis object data while shifting a phase of at least one of the template data and the M-th analysis object data, M being an integer of 1 or more and N or less, and the template data being time-series data including a signal component to be analyzed; and
a synchronous-timing detection circuit configured to detect a synchronous timing, which is a timing synchronizing with the signal component to be analyzed, with respect to the first to N-th analysis object data based on the product-sum operation data, in which the template data is shorter than the M-th analysis object data, and a sampling rate of the M-th analysis object data is equal to a sampling rate of the template data.

### BRIEF DESCRIPTION OF THE DRAWINGS

FIG. 1 is a flowchart showing a procedure of a signal processing method according to a first embodiment.

FIG. 2 is a flowchart showing an example of a procedure of a template data generation step in the first embodiment.

FIG. 3 is a flowchart showing an example of a procedure of an analysis object data generation step in the first embodiment.

FIG. 4 is a flowchart showing an example of a procedure of a product-sum operation step in the first embodiment.

FIG. 5 is a flowchart showing an example of a procedure of a synchronous-timing detection step in the first embodiment.

FIG. 6 is a diagram illustrating a specific example of an object.

FIG. 7 is a graph showing an example of first to third analysis object data.

FIG. 8 is a graph showing an example of template data.

FIG. 9 is a graph showing an example of product-sum operation data.

FIG. 10 is an enlarged view of product-sum operation data shown in FIG. 9.

FIG. 11 is an enlarged view of the second analysis object data shown in FIG. 7.

FIG. 12 is a diagram illustrating a configuration example of a signal processing device according to the first embodiment.

FIG. 13 is a flowchart showing an example of a procedure of a synchronous-timing detection step in a second embodiment.

FIG. 14 is a graph showing a frequency spectrum obtained by performing FFT processing on the second analysis object data shown in FIG. 7.

FIG. 15 is a graph showing a frequency spectrum obtained by performing FFT processing on the product-sum operation data shown in FIG. 9.

FIG. 16 is a graph showing time-series data obtained by performing band-pass filter processing on the product-sum operation data shown in FIG. 9.

FIG. 17 is a graph showing time-series data obtained by performing band-pass filter processing on the product-sum operation data illustrated in FIG. 9.

FIG. 18 is a flowchart showing a procedure of a signal processing method according to a third embodiment.

FIG. 19 is a flowchart showing an example of a procedure of a synchronous addition step S5 in the third embodiment.

FIG. 20 is a graph showing second synchronously-added data obtained by performing synchronous addition on the second analysis object data shown in FIG. 7.

FIG. 21 is a graph showing first to third synchronously-added data obtained by performing synchronous addition on the first to third analysis object data shown in FIG. 7.

FIG. 22 is a diagram illustrating a configuration example of a signal processing device according to the third embodiment.

FIG. 23 is a flowchart showing an example of a procedure of a template data generation step in a fourth embodiment.

FIG. 24 is a flowchart showing an example of a procedure of an analysis object data generation step in the fourth embodiment.

FIG. 25 is a flowchart showing a procedure of a signal processing method according to a fifth embodiment.

FIG. 26 is a graph showing an example of template data.

FIG. 27 is a graph showing time-series data obtained by performing synchronous addition on the second analysis object data shown in FIG. 7.

FIG. 28 is a flowchart showing an example of a procedure of a template data generation step in a sixth embodiment.

FIG. 29 is a flowchart showing an example of a procedure of an analysis object data generation step in the sixth embodiment.

FIG. 30 is an enlarged view of time-series data detected by a second sensor.

FIG. 31 is an enlarged view of time-series data obtained by performing spline interpolation on the time-series data shown in FIG. 30.

FIG. 32 is a graph showing time-series data obtained by performing band-pass filter processing on product-sum operation data.

FIG. 33 is a graph showing first to third synchronously-added data.

FIG. 34 is a flowchart showing an example of a procedure of a synchronous-timing detection step according to a seventh embodiment.

FIG. 35 is a flowchart showing a procedure of a signal processing method according to an eighth embodiment.

### DESCRIPTION OF EMBODIMENTS

Hereinafter, preferred embodiments of the present disclosure will be described in detail with reference to the drawings. The embodiments to be described below do not unduly limit contents of the present disclosure described in the claims. In addition, not all configurations to be described below are necessarily essential components of the present disclosure.

### 1. First Embodiment

### 1-1. Signal Processing Method

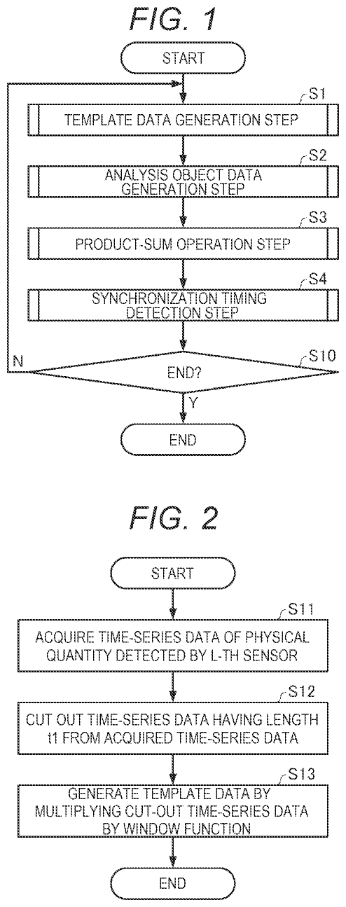

FIG. 1 is a flowchart showing a procedure of a signal processing method according to a first embodiment. As shown in FIG. 1, the signal processing method according to the first embodiment includes a template data generation step S1, an analysis object data generation step S2, a product-sum operation step S3, and a synchronous-timing detection step S4. The signal processing method according to the embodiment is performed by, for example, a signal processing device 1 illustrated in FIG. 12 described later.

First, in the template data generation step S1, the signal processing device 1 generates template data, which is time-series data including a signal component to be analyzed, based on time-series data of a physical quantity detected by an L-th sensor among first to N-th sensors provided in an object to be analyzed. N is a predetermined integer of 1 or more, and may be an integer of 2 or more. L is an integer of 1 or more and N or less.

The object is an object to be subjected to signal processing. A type of the object is not particularly limited, and the object may be, for example, various devices such as a motor having a rotating mechanism or a vibration mechanism, a structure such as a bridge or a building that vibrates due to an external force, or an electric circuit that generates a signal having cyclicity. For example, the signal processing device 1 may generate i-th analysis object data based on time-series data of a physical quantity detected by the i-th sensor in a steady state of the object. The steady state of the object is a state in which the object repeats a predetermined operation, and may be, for example, a state in which a device or a structure as the object rotates or vibrates, or a state in which an electric circuit as the object generates a signal having cyclicity. For example, a type of the physical quantity is not particularly limited, and the physical quantity may be a velocity, an acceleration, an angular velocity, a pressure, a current, a voltage, or the like.

The first to N-th sensors may be, for example, sensors using MEMS or sensors using a quartz crystal vibrator. MEMS is an abbreviation for micro electro mechanical systems. For example, the first to N-th sensors may be built in one sensor module, or at least one of the first to N-th sensors may be physically separated from the other sensors. IMU is an abbreviation for inertial measurement unit.

For example, the signal processing device 1 may generate template data based on time-series data in which an intensity of a signal component to be analyzed is the highest among time-series data of a physical quantity detected by the first to N-th sensors.

Next, in the analysis object data generation step S2, the signal processing device 1 generates i-th analysis object data for each integer i of 1 or more and N or less based on the time-series data of the physical quantity detected by the i-th sensor.

Next, in the product-sum operation step S3, the signal processing device 1 performs a plurality of times of product-sum operation processing on the template data generated in step S1 and M-th analysis object data generated in step S2 while shifting a phase of at least one of the template data and the M-th analysis object data, thereby generating product-sum operation data. M is an integer of 1 or more and N or less. The integer M may be the same as or different from the integer L.

Next, in the synchronous-timing detection step S4, based on the product-sum operation data generated in step S3, the signal processing device 1 detects a synchronous timing, which is a timing synchronizing with the signal component to be analyzed, with respect to the first to N-th analysis object data generated in step S2. Specifically, in the synchronous-timing detection step S4, the signal processing device 1 detects the synchronous timing based on a feature point of the product-sum operation data. The feature point may be a local maximum point, a zero-cross point, a local minimum point, or the like.

The signal processing device 1 repeats steps S1 to S4 until the signal processing is ended in step S10.

As described above, in the embodiment, the template data is updated every time the M-th analysis object data is updated until the signal processing ends. By updating the template data, the signal processing device 1 can generate the product-sum operation data including the signal component even when a cycle of the signal component to be analyzed included in the first to N-th analysis object data changes due to a temporal change of the state of the object.

In FIG. 1, the order of the template data generation step S1 and the analysis object data generation step S2 may be reversed. That is, the signal processing device 1 may perform the template data generation step S1 after performing the analysis object data generation step S2. The signal processing device 1 may perform the product-sum operation step S3 using template data generated in advance. That is, in FIG. 1, the template data generation step S1 may be omitted.

FIG. 2 is a flowchart showing an example of a procedure of the template data generation step S1 in FIG. 1.

As shown in FIG. 2, first, in step S11, the signal processing device 1 acquires the time-series data of the physical quantity detected by the L-th sensor.

Next, in step S12, the signal processing device 1 cuts out time-series data having a length t1 from the time-series data acquired in step S11.

Next, in step S13, the signal processing device 1 generates template data by multiplying the time-series data cut out in step S12 by a window function, and ends the template data generation step S1.

As described above, in the embodiment, the template data is time-series data having a time length of t1 that is obtained by multiplying, by a window function, data cut out from the time-series data of the physical quantity detected by the L-th sensor. By multiplying the window function, it is possible to reduce influence of noise caused by discontinuity between a first sample value and a last sample value of the template data on the product-sum operation data generated in step S3 in FIG. 1. A type of the window function is not particularly limited, and examples of the window function include a Hanning window function, a rectangular window function, a Gaussian window function, a Hamming window function, a Blackman window function, and a Kaiser window function.

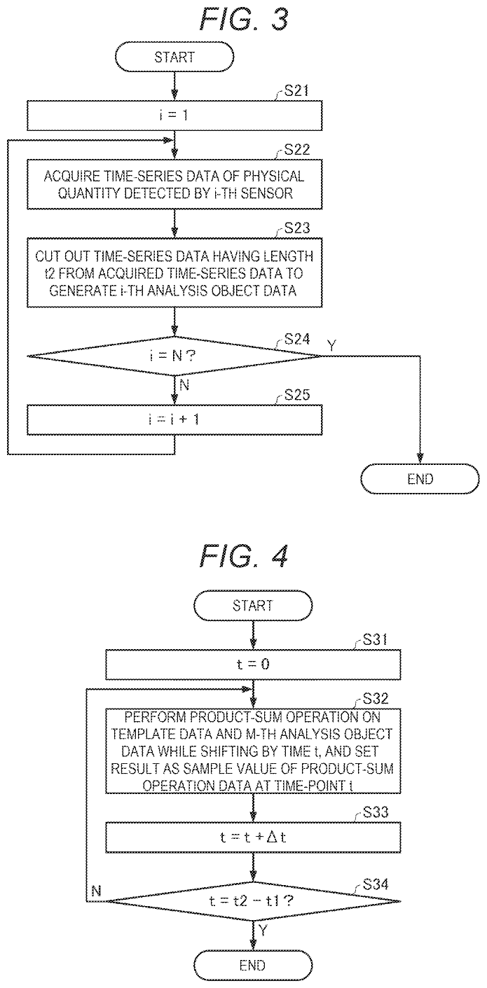

FIG. 3 is a flowchart showing an example of the procedure of the analysis object data generation step S2 in FIG. 1.

As shown in FIG. 3, first, the signal processing device 1 sets i=1 in step S21, and acquires the time-series data of the physical quantity detected by the i-th sensor in step S22.

Next, in step S23, the signal processing device 1 cuts out time-series data having a length t2 from the time-series data acquired in step S22 to generate the i-th analysis object data.

Next, the signal processing device 1 sets i=i+1 in step S25 and repeats steps S22 to S25 until i=N in step S24. When i=N in step S24, the signal processing device 1 ends the analysis object data generation step S2.

In the embodiment, the template data is shorter than the M-th analysis object data. That is, t1<t2.

FIG. 4 is a flowchart showing an example of a procedure of the product-sum operation step S3 in FIG. 1.

As shown in FIG. 4, first, in step S31, the signal processing device 1 sets t=0, and in step S32, the signal processing device 1 performs a product-sum operation on the template data generated in step S1 in FIG. 1 and the analysis object data generated in step S2 in FIG. 1 while shifting by time-point t, and sets a result as a sample value of the product-sum operation data at a time-point t.

Next, the signal processing device 1 sets t=t+Δt in step S33, and repeats steps S32 and S33 until t=t2−t1 in step S34. When t=t2−t1 in step S34, the signal processing device 1 ends the product-sum operation step S3.

As described above, in the embodiment, the signal processing device 1 generates product-sum operation data by performing product-sum operation processing on the template data and the M-th analysis object data while shifting the time t until the time t coincides with the difference between the time length t2 of the M-th analysis object data and the time length t1 of the template data.

The product-sum operation processing may be FIR filter processing for the M-th analysis object data. FIR is an abbreviation for finite impulse response. In this case, a coefficient of the FIR filter processing is defined based on the template data. For example, by sequentially inputting n2 sample values included in the M-th analysis object data to an FIR filter of n1 taps that have n1 sample values included in the template data as n1 coefficient values, product-sum operation data is obtained as an output signal of the FIR filter. Note that n1=t1/Δt and n2=t2/Δt. Since the FIR filter processing is often included in a library of a system as a standard, the product-sum operation processing can be implemented easily by the FIR filter processing.

The time length t1 of the template data is preferably longer than the cycle of the signal component to be analyzed, and the difference t2−t1 between the time length t2 of the M-th analysis object data and the time length t1 of the template data is preferably longer than the cycle of the signal component to be analyzed. Accordingly, the product-sum operation data includes the signal component to be analyzed of one or more cycles.

When the integer L and the integer M are the same, the signal processing device 1 may generate the template data based on time-series data of a first period included in the time-series data of the physical quantity detected by the L-th sensor in the template data generation step S1, and may generate the M-th analysis object data based on time-series data of a second period not overlapping the first period included in the time-series data of the physical quantity detected by the M-th sensor in the analysis object data generation step S2. In this way, since there is no period in which the template data and the M-th analysis object data include exactly the same signal 1 waveform, product-sum operation data in which the signal component having an ergodic property such as noise is effectively reduced is obtained in the product-sum operation step S3.

In the embodiment, a sampling rate of the M-th analysis object data is equal to a sampling rate of the template data. Accordingly, in the product-sum operation processing, orthogonality of signal components having different frequencies is secured, and signal components having the same frequency are correctly extracted. The sampling rate of the M-th analysis object data and the sampling rate of the template data being equal to each other includes not only a case where the sampling rates of the M-th analysis object data and the template data are strictly equal to each other, but also a case where the sampling rates of the M-th analysis object data and the template data are slightly different from each other and are effectively equal to each other as long as the above-described effect is obtained in the product-sum operation processing. In the procedures in FIGS. 2 and 3, the time-series data of the physical quantity detected by each of the L-th sensor and the M-th sensor is data at a constant sampling rate, and if the integer L and the integer M are the same, the M-th analysis object data and the template data are data cut out from the same time-series data. Accordingly, the sampling rate of the M-th analysis object data is strictly equal to the sampling rate of the template data. When the integer L and the integer M are different from each other, the sampling rate of the M-th sensor and the sampling rate of the L-th sensor are actually slightly different from each other even if both are the same in specifications. In this case, it can be said that the sampling rate of the M-th analysis object data and the sampling rate of the template data are slightly different but are effectively equal to each other.

However, a sampling rate of time-series data that is a source of the M-th analysis object data may be different from a sampling rate of time-series data that is a source of the template data. In this case, before the product-sum operation step S3, the signal processing device 1 may perform spline conversion, linear conversion, or the like on one of the two pieces of time-series data having different sampling rates to generate M-th analysis object data and template data having the same sampling rate.

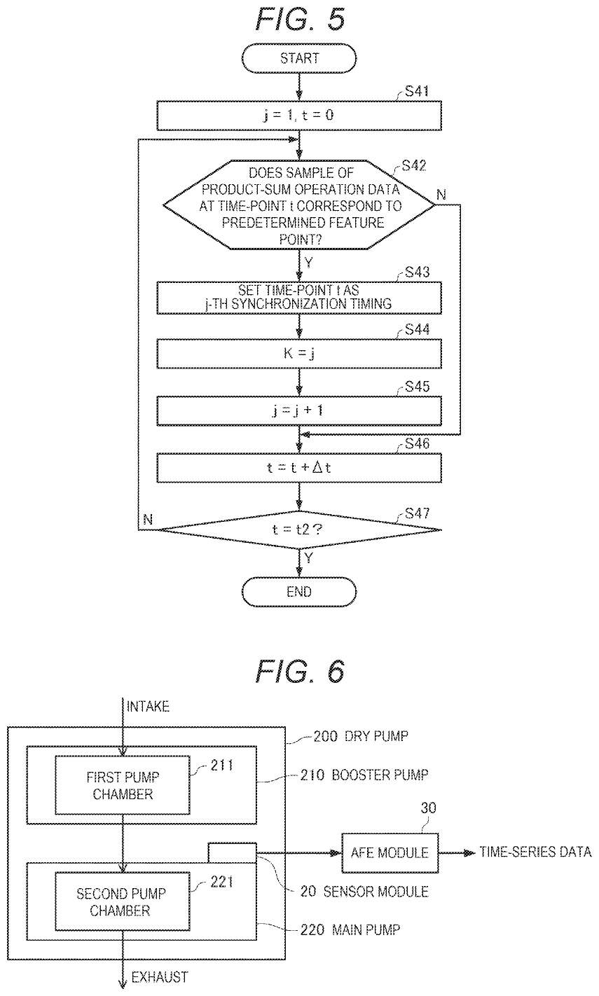

FIG. 5 is a flowchart showing an example of a procedure of the synchronous-timing detection step S4 in FIG. 1.

As shown in FIG. 5, first, in step S41, the signal processing device 1 sets j=1 and t=0, and in step S42, the signal processing device 1 determines whether a sample at the time-point t of the product-sum operation data generated in the procedure in FIG. 4 corresponds to a predetermined feature point. The feature point may be a local maximum point, a zero-cross point, a local minimum point, or the like.

When it is determined in step S42 that the sample at the time-point t corresponds to the predetermined feature point, the signal processing device 1 sets the time-point t as a j-th synchronous timing in step S43.

Next, the signal processing device 1 sets K=j in step S44, sets j=j+1 in step S45, and sets t=t+Δt in step S46. When it is determined in step S42 that the sample at the time-point t does not correspond to the predetermined feature point, the signal processing device 1 does not perform steps S43, S44, and S45.

The signal processing device 1 repeats steps S42 to S46 until t=t2 in step S47, and when t=t2 in step S47, ends the synchronous-timing detection step S4.

By the procedure in FIG. 5, first to K-th synchronous timings and the number K thereof are obtained.

### 1-2. Specific Examples of Signal Processing

FIG. 6 is a diagram illustrating a specific example of the object. In the example in FIG. 6, the object is a dry pump 200, and the dry pump 200 includes a booster pump 210 and a main pump 220. The booster pump 210 includes a first pump chamber 211, and rotates a rotor (not shown) accommodated in the first pump chamber 211 at a high speed by the action of a motor, a gear, a bearing, and the like (not shown) built therein. Accordingly, the first pump chamber 211 suctions air from the outside of the dry pump 200 and discharges the air.

The main pump 220 includes a second pump chamber 221, and rotates a rotor (not shown) accommodated in the second pump chamber 221 at a high speed by the action of a motor, a gear, a bearing, and the like (not shown) built therein. Accordingly, the second pump chamber 221 suctions the air discharged from the first pump chamber 211 and discharges the air to the outside of the dry pump 200.

In a steady state of the dry pump 200, the motor, the gear, the bearing, the rotor, and the like built in the booster pump 210 and the motor, the gear, the bearing, the rotor, and the like built in the main pump 220 are operated, and vibrations of various frequencies are generated by the operations thereof. A sensor module 20 is installed at a position where the vibration is transmitted. The sensor module 20 includes first to N-th sensors (not shown) therein. For example, the sensor module 20 may be a three-axis velocity sensor, a first sensor may be a velocity sensor that detects a velocity in an x-axis direction, a second sensor may be a velocity sensor that detects a velocity in a y-axis direction, and a third sensor may be a velocity sensor that detects a velocity in a z-axis direction. As long as the sensor module 20 is capable of detecting a vibration, the sensor module 20 may be, for example, an acceleration sensor or an angular velocity sensor. As long as the sensor module 20 is able to detect a slight vibration, a restriction of an installation location thereof is small.

An output signal of the sensor module 20 is input to an analog front-end module 30. The analog front-end module 30 performs amplification processing and A/D conversion processing on the output signal of the sensor module 20 and outputs digital time-series data.

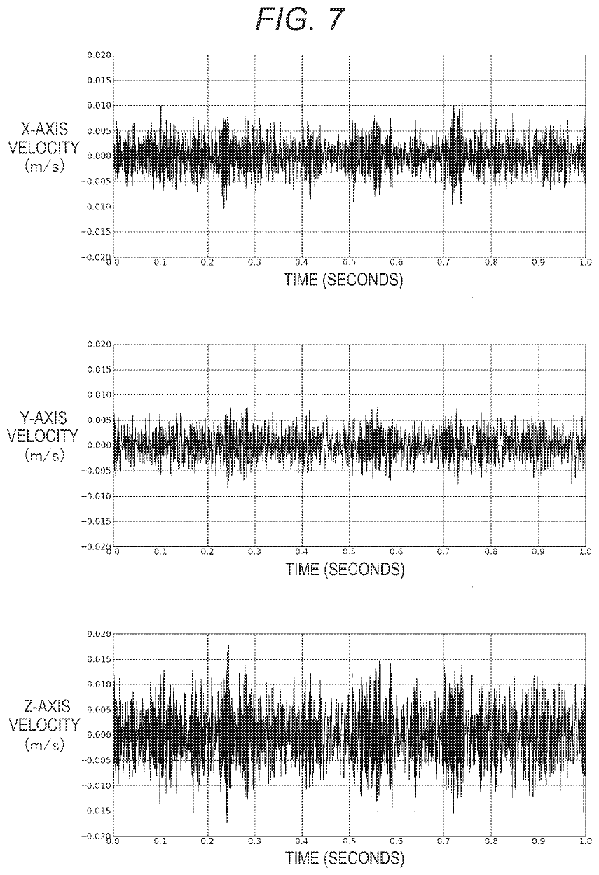

FIG. 7 is a graph showing an example of first to third analysis object data generated based on time-series data of three-axis velocities detected by the sensor module 20. In FIG. 7, data of an upper section is the first analysis object data, data of a middle section is the second analysis object data, and data of a lower section is the third analysis object data. That is, the first analysis object data is time-series data of an x-axis velocity, the second analysis object data is time-series data of a y-axis velocity, and the third analysis object data is time-series data of a z-axis velocity.

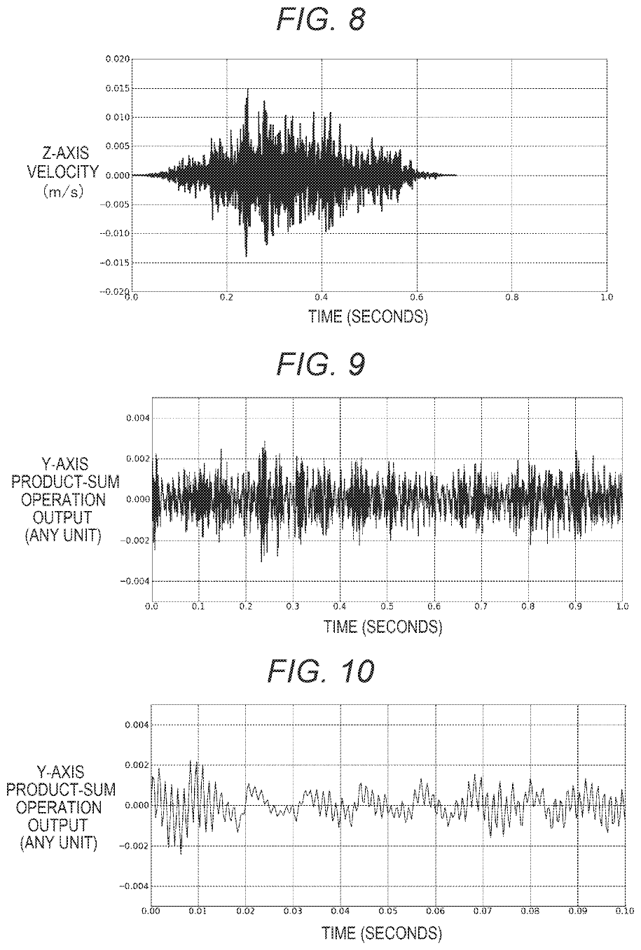

FIG. 8 is a graph showing an example of template data. The template data shown in FIG. 8 is data generated by multiplying the Hanning window function by time-series data cut out from the time-series data of the z-axis velocity detected by the z-axis velocity sensor provided in the sensor module 20.

FIG. 9 is a graph showing an example of product-sum operation data. The product-sum operation data shown in FIG. 9 is time-series data obtained by the product-sum operation processing on the time-series data of the z-axis velocity that is the template data shown in FIG. 8 and the time-series data of the y-axis velocity that is the second analysis object data shown in FIG. 7.

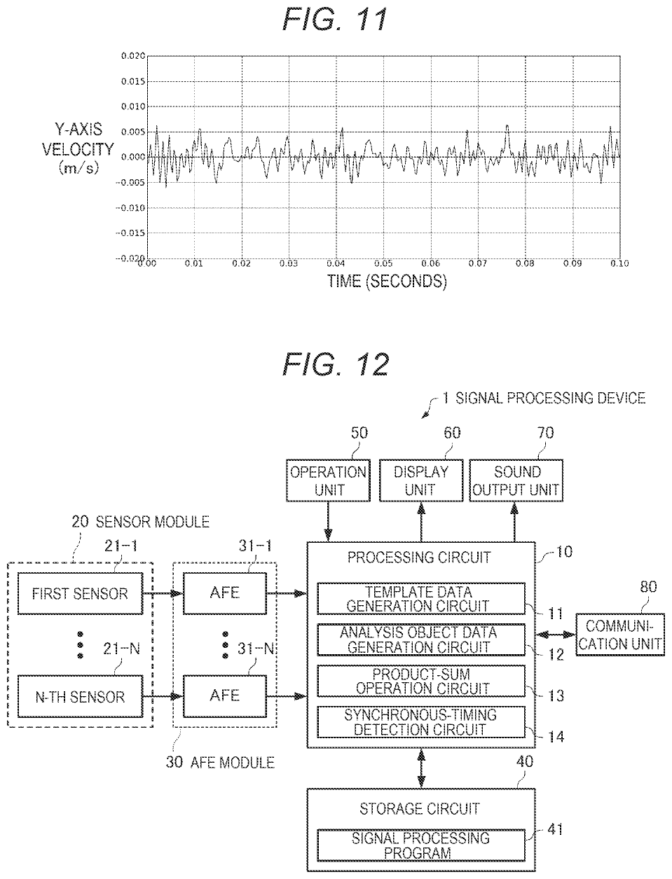

FIG. 10 is an enlarged view of a range of 0 seconds to 0.1 seconds of the product-sum operation data shown in FIG. 9. FIG. 11 is an enlarged view of a range of 0 seconds to 0.1 seconds of the time-series data of the y-axis velocity that is the second analysis object data shown in FIG. 7.

The first to third analysis object data shown in FIG. 7 and the template data shown in FIG. 8 include signal components of various frequencies caused by operations of the motor, the gear, the bearing, the rotor, and the like built in the booster pump 210 and the motor, the gear, the bearing, the rotor, and the like built in the main pump 220. Through the product-sum operation processing, signal components of the same frequency included in both the template data and the second analysis object data are amplified. On the other hand, among signal components not correlated with the operation of the dry pump 200, noise having an ergodic property is attenuated by the product-sum operation processing. Therefore, when FIG. 10 and FIG. 11 are compared with each other, it can be seen that a cycle of a feature point such as the local maximum point or the local minimum point of a signal component to be analyzed correlated with the operation of the dry pump 200 is emphasized by the product-sum operation processing. For example, local maximum points of the product-sum operation data shown in FIG. 9 are detected as the first to K-th synchronous timings.

### 1-3. Configuration of Signal Processing Device

FIG. 12 is a diagram illustrating a configuration example of the signal processing device 1 that implements the signal processing method according to the first embodiment. As illustrated in FIG. 12, the signal processing device 1 includes a processing circuit 10, first to N-th sensors 21-1 to 21-N, analog front ends 31-1 to 31-N, a storage circuit 40, an operation unit 50, a display unit 60, a sound output unit 70, and a communication unit 80. The signal processing device 1 may have a configuration in which some of the components in FIG. 12 are omitted or changed, or other components are added. For example, the first to N-th sensors 21-1 to 21-N and the analog front ends 31-1 to 31-N may not be components of the signal processing device 1.

Each of the first to N-th sensors 21-1 to 21-N is provided in an object to be analyzed, detects a physical quantity, and outputs a signal having a magnitude corresponding to the detected physical quantity. The first to N-th sensors 21-1 to 21-N may be built in one sensor module 20. For example, the physical quantity may be a velocity, an acceleration, an angular velocity, a pressure, a current, or a voltage. Output signals of the first to N-th sensors 21-1 to 21-N are input to the analog front ends 31-1 to 31-N, respectively.

The analog front ends 31-1 to 31-N perform amplification processing, A/D conversion processing, or the like on the output signals of the first to N-th sensors 21-1 to 21-N, and output digital time-series data. The analog front ends 31-1 to 31-N may be built in one analog front-end module 30.

The processing circuit 10 acquires N pieces of time-series data output from the analog front ends 31-1 to 31-N and performs signal processing. Specifically, the processing circuit 10 executes a signal processing program 41 stored in the storage circuit 40 and performs various types of calculation processing on the N pieces of time-series data. In addition, the processing circuit 10 performs various types of processing according to an operation signal from the operation unit 50, processing of transmitting a display signal for causing the display unit 60 to display various types of information, processing of transmitting a sound signal for causing the sound output unit 70 to generate various types of sounds, processing of controlling the communication unit 80 to perform data communication with an external device, and the like. The processing circuit 10 is implemented by, for example, a CPU or a DSP. The CPU is an abbreviation for central processing unit, and the DSP is an abbreviation for digital signal processor.

The processing circuit 10 functions as a template data generation circuit 11, an analysis object data generation circuit 12, a product-sum n operation circuit 13, and a synchronous-timing detection circuit 14 by executing the signal processing program 41. That is, the signal processing device 1 includes the template data generation circuit 11, the analysis object data generation circuit 12, the product-sum operation circuit 13, and the synchronous-timing detection circuit 14.

The template data generation circuit 11 generates template data, which is time-series data including a signal component to be analyzed, based on time-series data of the physical quantity detected by the L-th sensor 21-L provided in the object to be analyzed. L is an integer of 1 or more and N or less. That is, the template data generation circuit 11 executes the template data generation step S1 in FIG. 1, specifically, steps S11 to S13 in FIG. 2. The template data generated by the template data generation circuit 11 is stored in the storage circuit 40.

The analysis object data generation circuit 12 generates, for each integer i of 1 or more and N or less, i-th analysis object data based on time-series data of the physical quantity detected by an i-th sensor provided in the object to be analyzed. N is an integer of 1 or more. That is, the analysis object data generation circuit 12 executes the analysis object data generation step S2 in FIG. 1, specifically, steps S21 to S25 in FIG. 3. The first to N-th analysis object data generated by the analysis object data generation circuit 12 are stored in the storage circuit 40.

The product-sum operation circuit 13 generates product-sum operation data by performing a plurality of times of product-sum operation processing on the template data generated by the template data generation circuit 11 and M-th analysis object data generated by the analysis object data generation circuit 12 while shifting a phase of at least one of the template data and the M-th analysis object data. M is an integer of 1 or more and N or less. The integer M may be the same as or different from the integer L. That is, the product-sum operation circuit 13 executes the product-sum operation step S3 in FIG. 1, specifically, steps S31 to S34 in FIG. 4. The product-sum operation data generated by the product-sum operation circuit 13 is stored in the storage circuit 40.

Based on the product-sum operation data generated by the product-sum operation circuit 13, the synchronous-timing detection circuit 14 detects a synchronous timing, which is a timing synchronizing with a signal component to be analyzed, with respect to the first to N-th analysis object data generated by the analysis object data generation circuit 12. That is, the synchronous-timing detection circuit 14 executes the synchronous-timing detection step S4 in FIG. 1, specifically, steps S41 to S47 in FIG. 5. The synchronous timing detected by the synchronous-timing detection circuit 14 is stored in the storage circuit 40.

The storage circuit 40 includes a ROM and a RAM (not shown). The ROM is an abbreviation for read only memory, and the RAM is an abbreviation for random access memory. The ROM stores various programs such as the signal processing program 41 and predetermined data, and the RAM stores data generated by the processing circuit 10. The RAM is also used as a work area of the processing circuit 10, and stores programs and data read from the ROM, data received from the operation unit 50, and data temporarily generated by the processing circuit 10.

The operation unit 50 is an input device including an operation key, a button switch, or the like, and outputs an operation signal corresponding to an operation of a user to the processing circuit 10.

The display unit 60 is a display device implemented by an LCD or the like, and displays various types of information based on a display signal output from the processing circuit 10. The LCD is an abbreviation for liquid crystal display. The display unit 60 may be provided with a touch panel functioning as the operation unit 50. For example, the display unit 60 may display a screen including at least a portion of various types of data stored in the storage circuit 40, based on the display signal output from the processing circuit 10.

The sound output unit 70 is implemented by a speaker or the like, and generates various sounds based on a sound signal output from the processing circuit 10. For example, the sound output unit 70 may generate a sound indicating start or end of the signal processing, based on the sound signal output from the processing circuit 10.

The communication unit 80 performs various types of control for establishing data communication between the processing circuit 10 and an external device. For example, the communication unit 80 may transmit at least partial information of various types of data stored in the storage circuit 40 to an external device, and the external device may display the received information on a display unit (not shown).

At least some of the template data generation circuit 11, the analysis object data generation circuit 12, the product-sum operation circuit 13, and the synchronous-timing detection circuit 14 may be implemented by dedicated hardware. The signal processing device 1 may be a single device or may be implemented by a plurality of devices. For example, the first to N-th sensors 21-1 to 21-N and the analog front ends 31-1 to 31-N may be provided in a first device, and the processing circuit 10, the storage circuit 40, the operation unit 50, the display unit 60, the sound output unit 70, and the communication unit 80 may be provided in a second device separate from the first device. For example, the processing circuit 10 and the storage circuit 40 may be implemented by a device such as a cloud server, the device may generate product-sum operation data and detect a synchronous timing, and transmit the generated product-sum operation data and the detected synchronous timing to a terminal including the operation unit 50, the display unit 60, the sound output unit 70, and the communication unit 80 via a communication line.

### 1-4. Operation and Effect

In the signal processing method according to the first embodiment described above, since a signal component synchronizing with the signal component to be analyzed included in common in the template data and the M-th analysis object data is strengthened by the product-sum operation processing, even when an intensity of the signal component to be analyzed is relatively low, product-sum operation data in which the signal component is extracted can be obtained. Since the sampling rate of the M-th analysis object data is equal to the sampling rate of the template data, orthogonality of each of the signal components having different frequencies is secured in the product-sum operation processing, and the signal component synchronizing with the signal component to be analyzed is correctly extracted. Since the product-sum operation processing is not operation processing in a frequency domain but operation processing in a time domain, even if the signal component to be analyzed contains jitter or does not have a constant cycle, the product-sum operation data in which the signal component is extracted can be obtained. Therefore, according to the signal processing method of the first embodiment, the signal processing device 1 can accurately detect a timing synchronizing with the signal component to be analyzed included in the product-sum operation data.

According to the signal processing method of the first embodiment, the signal processing device 1 can accurately detect the timing synchronizing with the signal component to be analyzed, based on a clear feature point of the product-sum operation data.

Further, according to the signal processing method of the first embodiment, since the template data is updated, even if the cycle of the signal component to be analyzed is changed due to the temporal change in the state of the object, the product-sum operation data including the signal component can be obtained. Accordingly, the signal processing device 1 can detect the timing synchronizing with the signal component based on the product-sum operation data. In addition, as an update interval of the template data is shorter, a decrease in detection accuracy of the synchronous timing due to the temporal change in the state of the object is reduced.

Further, according to the signal processing method of the first embodiment, since the FIR filter processing is often included in a library of a system as a standard, the product-sum operation processing can be easily implemented.

According to the signal processing method of the first embodiment, the signal processing device 1 can accurately detect the timing synchronizing with the signal component to be analyzed by setting, as the M-th analysis object data, the data having the highest intensity of the signal component to be analyzed among the first to N-th analysis object data, N being an integer of 2 or more.

### 2. Second Embodiment

Hereinafter, regarding a second embodiment, the same components as those in the first embodiment are denoted by the same reference signs, and descriptions overlapping with those of the first embodiment are omitted or simplified, and contents different from those of the first embodiment will be mainly described.

Since a procedure of a signal processing method according to the second embodiment is the same as that in FIG. 1, illustration thereof is omitted. In the signal processing method according to the second embodiment, the processing and procedure of the synchronous-timing detection step S4 are different from those in the first embodiment.

In the second embodiment, in the synchronous-timing detection step S4, the signal processing device 1 detects a synchronous timing, which is a timing synchronizing with a signal component to be analyzed, with respect to the first to N-th analysis object data generated in step S2 in FIG. 1, based on a feature point of time-series data obtained by performing filter processing on product-sum operation data.

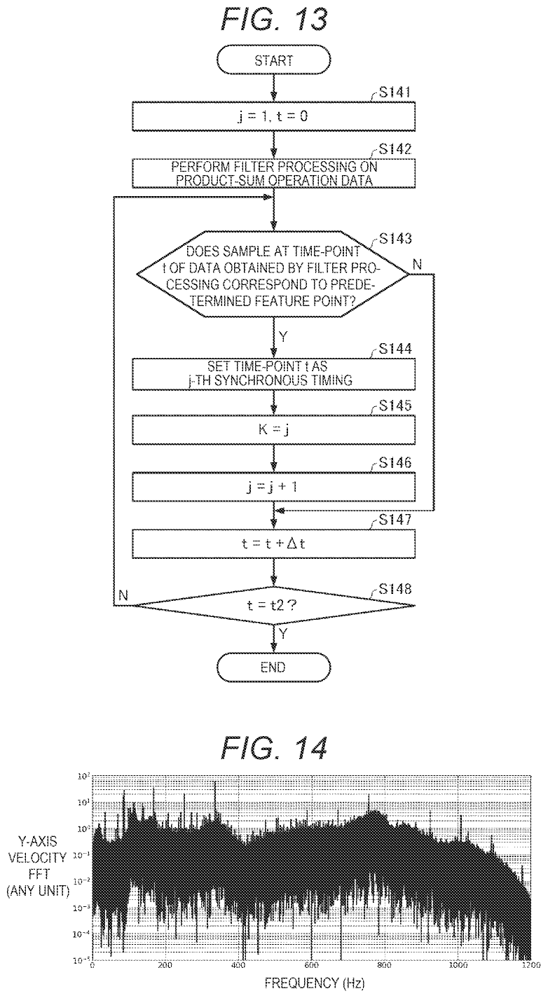

FIG. 13 is a flowchart showing an example of the procedure of the synchronous-timing detection step S4 in the second embodiment.

As shown in FIG. 13, first, in step S141, the signal processing device 1 sets j=1 and t=0, and in step S142, the signal processing device 1 performs filter processing on the product-sum operation data generated in the procedure in FIG. 4. The filter processing is processing for reducing unnecessary signal components, and may be DC cut filter processing, low-pass filter processing, band-pass filter processing, or the like. Data obtained by performing filter processing on the product-sum operation data is time-series data in which the signal component to be analyzed is emphasized.

Next, in step S143, the signal processing device 1 determines whether a sample at the time-point t of the data, which is obtained by performing filter processing on the product-sum operation data in step S142, corresponds to a predetermined feature point. The feature point may be a local maximum point, a zero-cross point, a local minimum point, or the like.

When it is determined in step S143 that the sample at the time-point t corresponds to the predetermined feature point, the signal processing device 1 sets the time-point t as a j-th synchronous timing in step S144.

Next, the signal processing device 1 sets K=j in step S145, sets j=j+1 in step S146, and sets t=t+Δt in step S147. When it is determined in step S143 that the sample at the time-point t does not correspond to the predetermined feature point, the signal processing device 1 does not perform steps S144, S145, and S146.

The signal processing device 1 repeats steps S142 to S147 until t=t2 in step S148, and when t=t2 in step S148, ends the synchronous-timing detection step S4.

By the procedure in FIG. 13, first to K-th synchronous timings and the number K thereof are obtained.

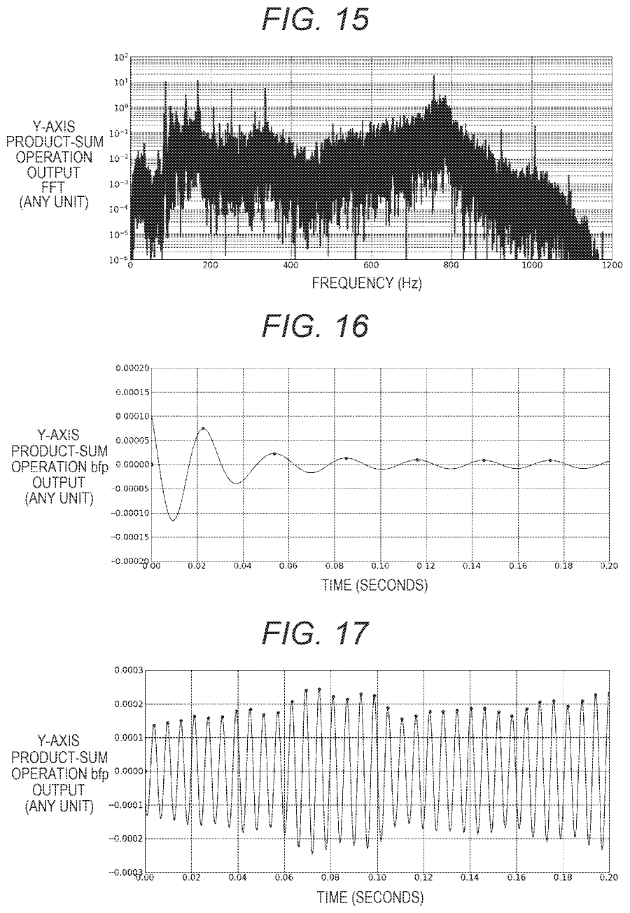

FIG. 14 is a graph showing a frequency spectrum obtained by performing FFT processing on the time-series data of the y-axis velocity that is the second analysis object data shown in FIG. 7. FIG. 15 is a graph showing a frequency spectrum obtained by performing FFT processing on the product-sum operation data shown in FIG. 9. FFT is an abbreviation for fast Fourier transform. In the frequency spectrum shown in FIG. 15, since a large number of peaks are confirmed, it can be seen that the product-sum operation data contains a large number of signal components having different frequencies.

FIG. 16 is a graph showing time-series data obtained by performing band-pass filter processing on the product-sum operation data shown in FIG. 9 with a passband of 30 Hz to 50 Hz. In the time-series data shown in FIG. 16, a signal component of 36.4 Hz to be analyzed is emphasized, and for example, time-points of respective local maximum points of the signal component of 36.4 Hz are detected as the first to K-th synchronous timings. In FIG. 16, each local maximum point of the signal component of 36.4 Hz is indicated by a black point.

FIG. 17 is a graph showing time-series data obtained by performing band-pass filter processing on the product-sum operation data shown in FIG. 9 with a passband of 150 Hz to 220 Hz. In the time-series data shown in FIG. 17, a signal component of 168.0 Hz to be analyzed is emphasized, and for example, time-points of respective local maximum points of the signal component of 168.0 Hz are detected as the first to K-th synchronous timings. In FIG. 17, each local maximum point of the signal component of 168.0 Hz is indicated by a black point.

Since a configuration example of the signal processing device 1 according to the second embodiment is the same as that in FIG. 12, illustration thereof is omitted. The synchronous-timing detection circuit 14 detects a synchronous timing, which is a timing synchronizing with a signal component to be analyzed, with respect to first to N-th analysis object data generated by the analysis object data generation circuit 12, based on a feature point of time-series data obtained by performing filter processing on product-sum operation data generated by the product-sum operation circuit 13. That is, the synchronous-timing detection circuit 14 executes the synchronous-timing detection step S4 in FIG. 1, specifically, steps S141 to S148 in FIG. 13. The synchronous timing detected by the synchronous-timing detection circuit 14 is stored in the storage circuit 40. Other configurations and functions of the signal processing device 1 according to the second embodiment are the same as those in the first embodiment, and thus a description thereof will be omitted.

According to the signal processing method of the second embodiment described above, the signal component to be analyzed included in the product-sum operation data is emphasized by the filter processing. Accordingly, based on the product-sum operation data, the signal processing device 1 can accurately detect the timing synchronizing with the signal component to be analyzed.

### 3. Third Embodiment

Hereinafter, regarding a third embodiment, the same components as those in the first embodiment or the second embodiment are denoted by the same reference signs, descriptions overlapping with those of the first embodiment or the second embodiment are omitted or simplified, and contents different from those of the first embodiment or the second embodiment will be mainly described.

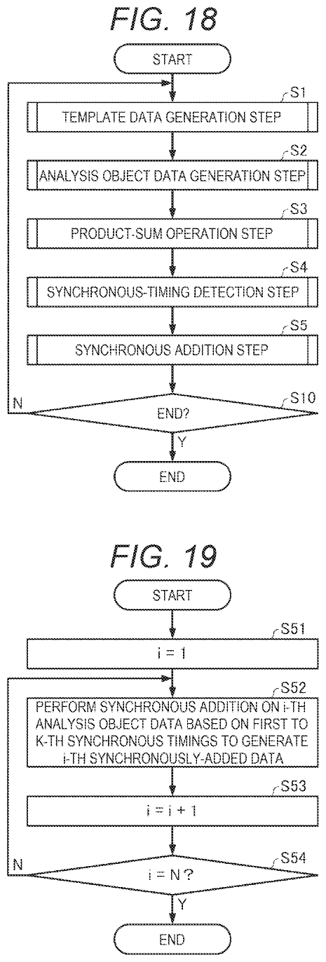

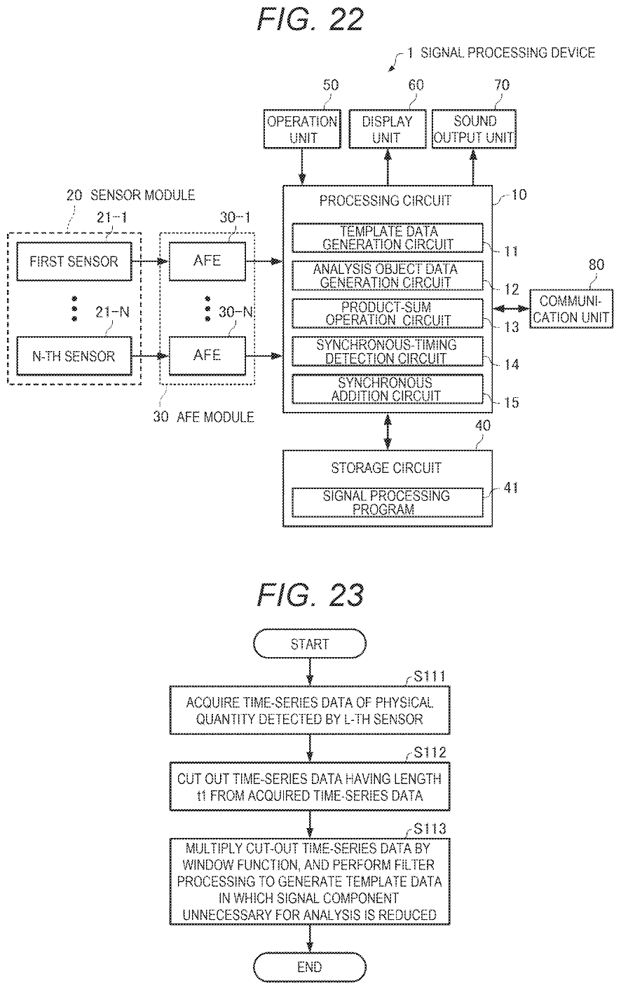

FIG. 18 is a flowchart showing a procedure of a signal processing method according to the third embodiment. As shown in FIG. 18, the signal processing method according to the third embodiment includes the template data generation step S1, the analysis object data generation step S2, the product-sum operation step S3, the synchronous-timing detection step S4, and a synchronous addition step S5. The signal processing method according to the embodiment is performed by, for example, the signal processing device 1 illustrated in FIG. 22 described later.

As shown in FIG. 18, first, the signal processing device 1 performs the template data generation step S1, the analysis object data generation step S2, the product-sum operation step S3, and the synchronous-timing detection step S4 as in the first embodiment or the second embodiment.

Next, in the synchronous addition step S5, for each integer i of 1 or more and N or less, the signal processing device 1 performs synchronous addition on the i-th analysis object data generated in step S2 based on the synchronous timings detected in step S4 to generate i-th synchronously-added data.

The signal processing device 1 repeats steps S1 to S5 until the signal processing is ended in step S10.

In FIG. 18, the order of the template data generation step S1 and the analysis object data generation step S2 may be reversed. That is, the signal processing device 1 may perform the template data generation step S1 after performing the analysis object data generation step S2. The signal processing device 1 may perform the product-sum operation step S3 using template data generated in advance. That is, in FIG. 18, the template data generation step S1 may be omitted.

FIG. 19 is a flowchart showing an example of a procedure of the synchronous addition step S5 in FIG. 18.

As shown in FIG. 19, first, the signal processing device 1 sets i=1 in step S51, and performs synchronous addition on the i-th analysis object data based on the first to K-th synchronous timings detected in the procedure shown in FIG. 5 to generate the i-th synchronously-added data in step S52.

Next, the signal processing device 1 sets i=i+1 in step S53 and repeats steps S52 and S53 until i=N in step S54. When i=N in step S54, the signal processing device 1 ends the synchronous addition step S5.

As described above, in the embodiment, the signal processing device 1 performs synchronous addition in synchronization with the signal component to be analyzed included in the product-sum operation data, with respect to each of the first to N-th analysis object data, thereby obtaining the i-th to N-th synchronously-added data in which the signal component to be analyzed is emphasized.

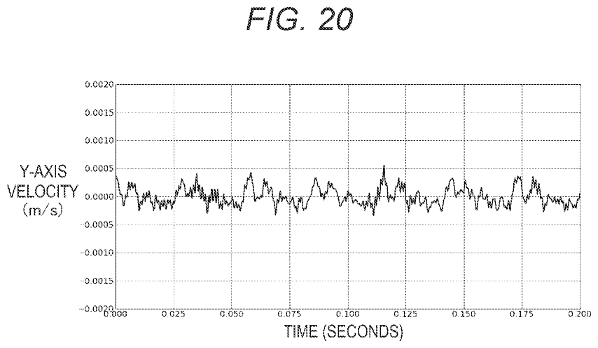

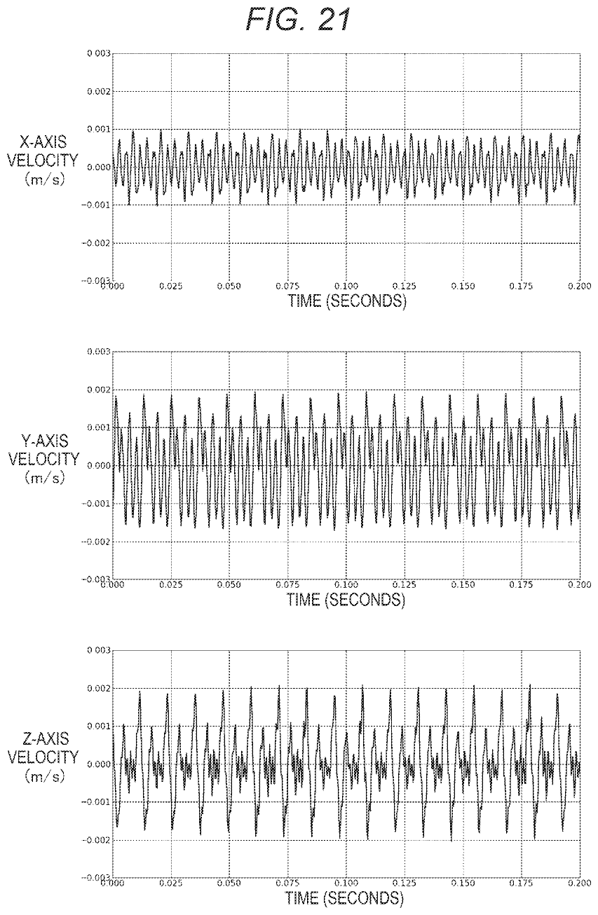

FIG. 20 is a graph showing second synchronously-added data obtained by performing synchronous addition on the time-series data of the y-axis velocity that is the second analysis object data shown in FIG. 7. The second synchronously-added data shown in FIG. 20 is time-series data obtained by using, as the first to K-th synchronous timings, the time-points of the respective local maximum points of the signal component of 36.4 Hz to be analyzed included in the time-series data shown in FIG. 16. In the second synchronously-added data shown in FIG. 20, a signal component synchronizing with the signal component of 36.4 Hz to be analyzed is extracted.

FIG. 21 is a graph showing first to third synchronously-added data obtained by performing synchronous addition on the first to third analysis object data shown in FIG. 7. The first to third synchronously-added data shown in FIG. 21 is time-series data obtained by using, as the first to K-th synchronous timings, the time-points of the respective local maximum points of the signal component of 168.0 Hz to be analyzed included in the time-series data shown in FIG. 17. In FIG. 21, data of an upper section is the first synchronously-added data, data of a middle section is the second synchronously-added data, and data of a lower section is the third synchronously-added data. That is, the first synchronously-added data is time-series data obtained by performing synchronous addition on the time-series data of the x-axis velocity that is the first analysis object data. The second synchronously-added data is time-series data obtained by performing synchronous addition on the time-series data of the y-axis velocity that is the second analysis object data. The third synchronously-added data is time-series data obtained by performing synchronous addition on the time-series data of the z-axis velocity that is the third analysis object data. In the first to third synchronously-added data shown in FIG. 21, a signal component synchronizing with the signal component of 168.0 Hz to be analyzed is extracted. In particular, as shown in FIG. 7, a vibration of the time-series data of the x-axis velocity that is the first analysis object data is larger than a vibration of the time-series data of the y-axis velocity that is the second analysis object data, but the signal component synchronizing with the signal component of 168.0 Hz is smaller in the first analysis object data than in the second analysis object data. Therefore, the signal processing device 1 can detect the first to K-th synchronous timings with high accuracy based on the time-series data in FIG. 17 based on the time-series data of the y-axis velocity that is the second analysis object data having a larger signal component synchronizing with the signal component of 168.0 Hz. The signal processing device 1 performs synchronous addition on the time-series data of the x-axis velocity that is the first analysis object data based on the first to K-th synchronous timings detected with high accuracy, thereby obtaining the first synchronously-added data in which the signal component synchronizing with the signal component of 168.0 Hz is extracted with high accuracy.

FIG. 22 illustrates a configuration example of the signal processing device 1 that implements the signal processing method according to the third embodiment. As illustrated in FIG. 22, the signal processing device 1 includes the processing circuit 10, the first to N-th sensors 21-1 to 21-N, the analog front ends 31-1 to 31-N, the storage circuit 40, the operation unit 50, the display unit 60, the sound output unit 70, and the communication unit 80. The signal processing device 1 may have a configuration in which some of the components in FIG. 22 are omitted or changed, or other components are added. For example, the first to N-th sensors 21-1 to 21-N and the analog front ends 31-1 to 31-N may not be components of the signal processing device 1.

The configurations and functions of the first to N-th sensors 21-1 to 21-N, the analog front ends 31-1 to 31-N, the storage circuit 40, the operation unit 50, the display unit 60, the sound output unit 70, and the communication unit 80 are the same as those in the first embodiment or the second embodiment, and thus a description thereof will be omitted.

The processing circuit 10 functions as the template data generation circuit 11, the analysis object data generation circuit 12, the product-sum operation circuit 13, the synchronous-timing detection circuit 14, and a synchronous addition circuit 15 by executing the signal processing program 41. That is, the signal processing device 1 includes the template data generation circuit 11, the analysis object data generation circuit 12, the product-sum operation circuit 13, the synchronous-timing detection circuit 14, and the synchronous addition circuit 15.

Since the functions of the template data generation circuit 11, the analysis object data generation circuit 12, the product-sum operation circuit 13, and the synchronous-timing detection circuit 14 are the same as those in the first embodiment or the second embodiment, a description thereof will be omitted. The template data generation circuit 11 executes the template data generation step S1 in FIG. 18, specifically, steps S11 to S13 in FIG. 2. The analysis object data generation circuit 12 executes the analysis object data generation step S2 in FIG. 18, specifically, steps S21 to S25 in FIG. 3. The product-sum operation circuit 13 executes the product-sum operation step S3 in FIG. 18, specifically, steps S31 to S34 in FIG. 4. The synchronous-timing detection circuit 14 executes the synchronous-timing detection step S4 in FIG. 18, specifically, steps S41 to S47 in FIG. 5 or steps S141 to S148 in FIG. 13.

For each integer i of 1 or more and N or less, the synchronous addition circuit 15 performs synchronous addition on the i-th analysis object data generated by the analysis object data generation circuit 12 based on the synchronous timings detected by the synchronous-timing detection circuit 14 to generate the i-th synchronously-added data. That is, the synchronous addition circuit 15 executes the synchronous addition step S5 in FIG. 18, specifically, steps S51 to S54 in FIG. 19. The first to N-th synchronously-added data generated by the synchronous addition circuit 15 are stored in the storage circuit 40.

The display unit 60 may display the first to N-th synchronously-added data generated by the synchronous addition circuit 15 based on a display signal output from the processing circuit 10. The communication unit 80 may transmit the first to N-th synchronously-added data to an external device.

At least some of the template data generation circuit 11, the analysis object data generation circuit 12, the product-sum operation circuit 13, the synchronous-timing detection circuit 14, and the synchronous addition circuit 15 may be implemented by dedicated hardware.

Other configurations and functions of the signal processing device 1 according to the third embodiment are the same as those of the first embodiment or the second embodiment, and thus a description thereof will be omitted.

According to the signal processing method of the third embodiment described above, by the synchronous addition based on the timing synchronizing with the signal component to be analyzed, the signal component synchronizing with the signal component to be analyzed is amplified, and a signal component not synchronizing with the signal component to be analyzed and a noise component are attenuated, and thus the signal component synchronizing with the signal component to be analyzed is extracted with high accuracy. In addition, since the signal processing device 1 can perform the synchronous addition based on the timing synchronizing with the signal component to be analyzed, the signal processing device 1 does not require a rotation pulse signal, and does not need to perform the synchronous addition assuming that a state of an object is any state.

According to the signal processing method of the third embodiment, the signal processing device 1 can accurately detect the timing synchronizing with the signal component to be analyzed by setting, as M-th analysis object data, data having the highest intensity of the signal component to be analyzed among the first to N-th analysis object data, N being an integer of 2 or more. Accordingly, even for other analysis object data in which the intensity of the signal component to be analyzed is lower than that of the M-th analysis object data, time-series data in which the signal component to be analyzed is extracted by the synchronous addition is obtained.

### 4. Fourth Embodiment

Hereinafter, regarding a fourth embodiment, the same components as any of those in the first to third embodiments are denoted by the same reference signs, descriptions overlapping with those of the first to third embodiments are omitted or simplified, and contents different from those of the first to third embodiments will be mainly described.

Since a procedure of a signal processing method according to the fourth embodiment is the same as that in FIG. 1 or FIG. 18, illustration thereof is omitted. In the signal processing method according to the fourth embodiment, the processing and procedures of the template data generation step S1 and the analysis object data generation step S2 are different from those of the first to third embodiments.

In the fourth embodiment, in the template data generation step S1, the signal processing device 1 generates template data in which a signal component unnecessary for analysis is reduced. Further, in the analysis object data generation step S2, the signal processing device 1 generates first to N-th analysis object data in which a signal component unnecessary for the analysis is reduced.

FIG. 23 is a flowchart showing an example of the procedure of the template data generation step S1 in the fourth embodiment.

As shown in FIG. 23, first, in step S111, the signal processing device 1 acquires time-series data of a physical quantity detected by an L-th sensor.

Next, in step S112, the signal processing device 1 cuts out time-series data having the length t1 from the time-series data acquired in step S111.

Next, in step S113, the signal processing device 1 multiplies the time-series data cut out in step S112 by a window function, performs filter processing to generate template data in which a signal component unnecessary for analysis is reduced, and ends the template data generation step S1. The filter processing may be DC cut filter processing, low-pass filter processing, band-pass filter processing, or the like.

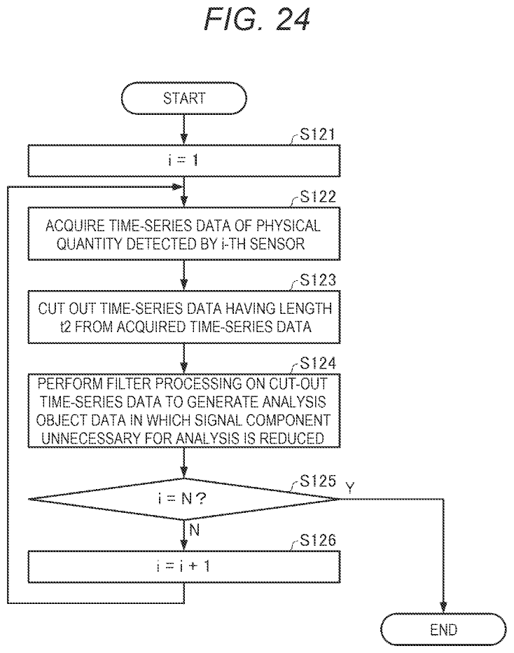

FIG. 24 is a flowchart showing an example of the procedure of the analysis object data generation step S2 in the fourth embodiment.

As shown in FIG. 24, first, the signal processing device 1 sets i=1 in step S121, and acquires time-series data of the physical quantity detected by the i-th sensor in step S122.

Next, in step S123, the signal processing device 1 cuts out time-series data having the length t2 from the time-series data acquired in step S122.

Next, in step S124, the signal processing device 1 performs filter processing on the time-series data cut out in step S123 to generate i-th analysis object data in which a signal component unnecessary for analysis is reduced. The filter processing may be DC cut filter processing, low-pass filter processing, band-pass filter processing, or the like.

Next, the signal processing device 1 sets i=i+1 in step S126 and repeats steps S122 to S126 until i=N in step S125. When i=N in step S125, the signal processing device 1 ends the analysis object data generation step S2.

As described above, according to the procedures in FIGS. 23 and 24, the template data and the first to N-th analysis object data are data in which a signal component unnecessary for analysis is reduced. Alternatively, for each integer i of 1 or more and N or less, only one of the template data and the i-th analysis object data may be data in which a signal component unnecessary for analysis is reduced. That is, in the embodiment, for each integer i of 1 or more and N or less, at least one of the template data and the i-th analysis object data is data in which a signal component unnecessary for analysis is reduced. Therefore, an unnecessary signal component to be reduced by synchronous addition is reduced before the synchronous addition, and first to N-th synchronously-added data in which the signal component to be analyzed is extracted is obtained even with a relatively small number of times of synchronous addition. For example, when a DC signal component that is not an object to be analyzed is reduced before product-sum operation processing, the DC signal component included in product-sum operation data obtained by the product-sum operation processing is reduced, and thus the maximum value of the product-sum operation data is reduced, and a data amount of the product-sum operation data or the first to N-th synchronously-added data is reduced. Accordingly, in the signal processing device 1, it is possible to reduce a size of the storage circuit 40 for storing the product-sum operation data and the first to N-th synchronously-added data.

Since a configuration example of the signal processing device 1 according to the fourth embodiment is the same as that in FIG. 22, illustration thereof is omitted. The template data generation circuit 11 performs the filter processing on the time-series data based on the time-series data of the physical quantity detected by the L-th sensor to generate the template data in which a signal component unnecessary for analysis is reduced. For each integer i of 1 or more and N or less, the analysis object data generation circuit 12 performs filter processing on the time-series data based on the time-series data of the physical quantity detected by the i-th sensor to generate the first to N-th analysis object data in which a signal component unnecessary for the analysis is reduced. Other configurations and functions of the signal processing device 1 according to the fourth embodiment are the same as any of those of the first to third embodiments, and thus a description thereof will be omitted.

As described above, according to the signal processing method of the fourth embodiment, the unnecessary signal component is reduced before the synchronous addition, and the signal component to be analyzed is correctly extracted by a relatively small number of times of the synchronous addition. Further, according to the signal processing method of the fourth embodiment, for example, when the DC signal component that is not an object to be analyzed is reduced before the product-sum operation processing, the maximum value of the product-sum operation data is reduced, and it is possible to reduce the data amount of the product-sum operation data or the first to N-th synchronously-added data.

### 5. Fifth Embodiment

Hereinafter, regarding a fifth embodiment, the same components as any of those in the first to fourth embodiments are denoted by the same reference signs, descriptions overlapping with those of the first to fourth embodiments are omitted or simplified, and contents different from those of the first to fourth embodiments will be mainly described.

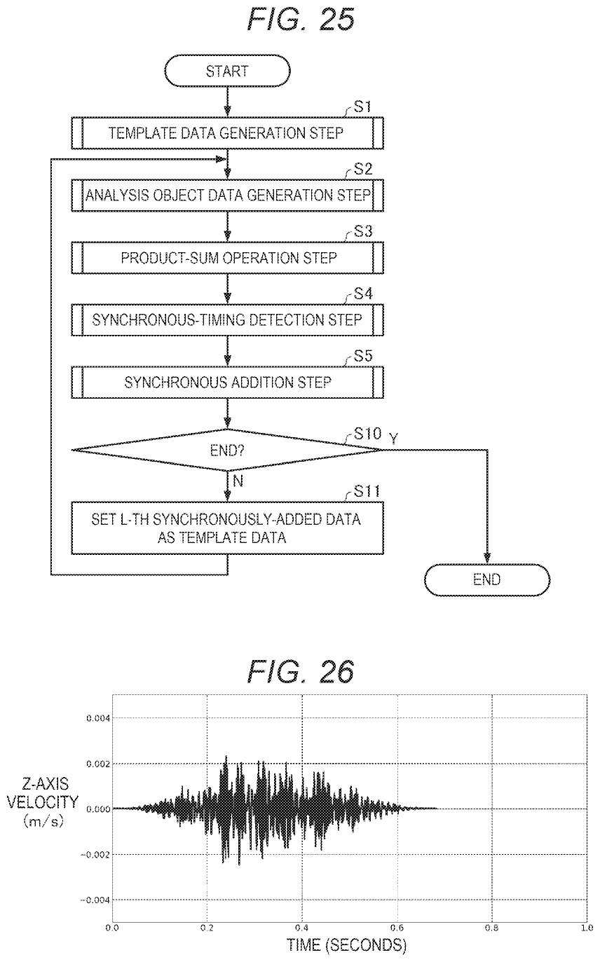

FIG. 25 is a flowchart showing a procedure of a signal processing method according to the fifth embodiment. As shown in FIG. 25, the signal processing method according to the fifth embodiment includes the template data generation step S1, the analysis object data generation step S2, the product-sum operation S3, step the synchronous-timing detection step S4, the synchronous addition step S5, and step S11. The signal processing method according to the embodiment is performed by, for example, the signal processing device 1 illustrated in FIG. 22.

As shown in FIG. 25, first, the signal processing device 1 performs the template data generation step S1, the analysis object data generation step S2, the product-sum operation step S3, the synchronous-timing detection step S4, and the synchronous addition step S5 as in the third embodiment.

Next, when the signal processing is not ended in step S10, the signal processing device 1 sets time-series data based on L-th synchronously-added data generated in step S5 as template data in step S11. For example, the signal processing device 1 may cut out time-series data having the length t1 from the L-th synchronously-added data and set, as the template data, time-series data obtained by multiplying the cut-out time-series data by a window function. Alternatively, the signal processing device 1 may multiply the cut-out time-series data by a window function and set time-series data, in which a signal component unnecessary for analysis is reduced by performing filter processing, as the template data.

The signal processing device 1 repeats S1 to S11 until the signal processing is ended in step S10.

As described above, in the embodiment, in the product-sum operation step S3 after the synchronous addition step S5, the signal processing device 1 generates product-sum operation data, using the time-series data based on the L-th synchronously-added data as the template data. Therefore, a signal component not correlated with the signal component to be analyzed is reduced, and the product-sum operation data in which the signal component to be analyzed is emphasized is obtained. The signal processing device 1 can detect first to K-th synchronous timings with high accuracy based on the product-sum operation data in which the signal component to be analyzed is emphasized. As a result, first to N-th synchronously-added data in which the signal component to be analyzed is extracted with high accuracy is obtained.

FIG. 26 is a graph showing an example of the template data. The template data shown in FIG. 26 is time-series data generated by multiplying the Hanning window function by time-series data cut out from the time-series data of the z-axis velocity that is the third synchronously-added data shown in FIG. 21.

FIG. 27 is a graph showing time-series data obtained by performing synchronous addition on the time-series data of the y-axis velocity, which is the second analysis object data, at first to K-th synchronous timings detected based on the template data shown in FIG. 26. In the second synchronously-added data shown in FIG. 27, a signal component synchronizing with the signal component of 168.0 Hz to be analyzed is extracted, and the signal component has a smaller fluctuation than the second synchronously-added data shown in FIG. 21. Accordingly, it can be seen that detection accuracy of the first to K-th synchronous timings is improved.

Since a configuration example of the signal processing device 1 according to the fifth embodiment is the same as that in FIG. 22, illustration thereof is omitted. After the synchronous addition circuit 15 generates the first to N-th synchronously-added data, the template data generation circuit 11 generates time-series data based on the L-th synchronously-added data as template data, and the product-sum operation circuit 13 generates product-sum operation data based on the template data. Other configurations and functions of the signal processing device 1 according to the fifth embodiment are the same as any of those of the first to fourth embodiments, and thus a description thereof will be omitted.

As described above, according to the signal processing method of the fifth embodiment, the signal component synchronizing with the signal component to be analyzed is extracted with high accuracy by the synchronous addition. Accordingly, the signal processing device 1 can accurately detect the timing synchronizing with the signal component to be analyzed, by performing the product-sum operation processing using the template data based on the time-series data obtained by the synchronous addition.

### 6. Sixth Embodiment

Hereinafter, regarding a sixth embodiment, the same components as any of those in the first to fifth embodiments are denoted by the same reference signs, descriptions overlapping with those of the first to fifth embodiments are omitted or simplified, and contents different from those of the first to fifth embodiments will be mainly described.

Since a procedure of a signal processing method according to the sixth embodiment is the same as that in FIG. 1, FIG. 18, or FIG. 25, illustration thereof is omitted. In the signal processing method according to the sixth embodiment, the processing and procedures of the template data generation step S1 and the analysis object data generation step S2 are different from those of the first to fifth embodiments.

In the sixth embodiment, in the template data generation step S1, the signal processing device 1 generates template data based on time-series data obtained by performing spline interpolation on time-series data cut out from time-series data of a physical quantity detected by an L-th sensor. In the analysis object data generation step S2, for each integer i of 1 or more and N or less, the signal processing device 1 generates i-th analysis object data based on time-series data obtained by performing spline interpolation on time-series data cut out from time-series data of the physical quantity detected by an i-th sensor.

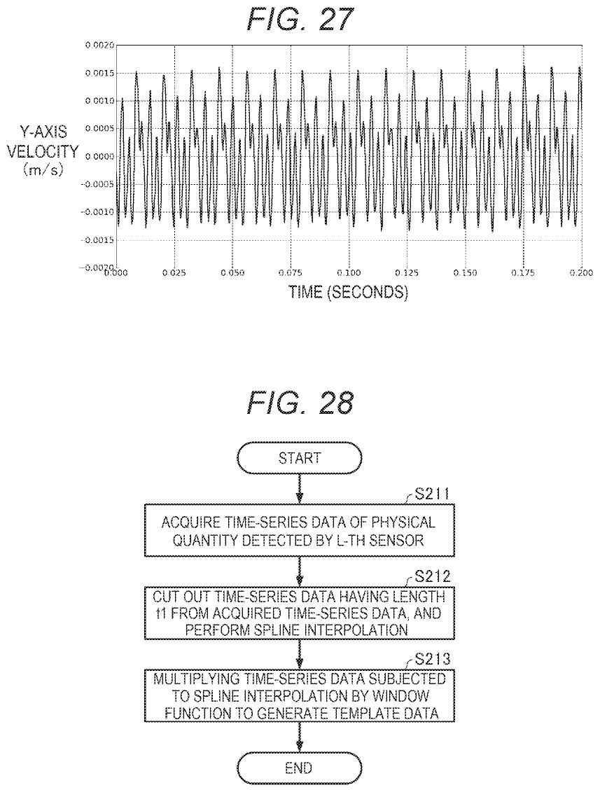

FIG. 28 is a flowchart showing an example of the procedure of the template data generation step S1 in the sixth embodiment.

As shown in FIG. 28, first, in step S211, the signal processing device 1 acquires the time-series data of the physical quantity detected by the L-th sensor.

Next, in step S212, the signal processing device 1 cuts out time-series data having the length t1 from the time-series data acquired in step S211, and performs spline interpolation.

Next, in step S213, the signal processing device 1 generates the template data by multiplying the time-series data subjected to spline interpolation in step S212 by a window function, and ends the template data generation step S1.

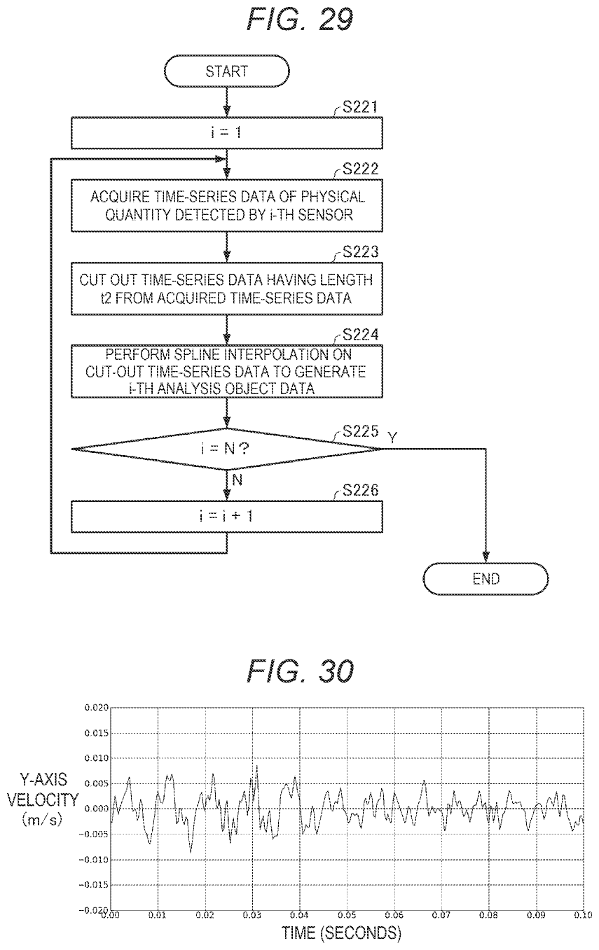

FIG. 29 is a flowchart showing an example of the procedure of the analysis object data generation step S2 in the sixth embodiment.

As shown in FIG. 29, first, the signal processing device 1 sets i=1 in step S221, and acquires time-series data of the physical quantity detected by the i-th sensor in step S222.

Next, in step S223, the signal processing device 1 cuts out time-series data having the length t2 from the time-series data acquired in step S222.

Next, in step S224, the signal processing device 1 performs spline interpolation on the time-series data cut out in step S223 to generate i-th analysis object data. Next, the signal processing device 1 sets i=i+1 in step S226 and repeats steps S222 to S226 until i=N in step S225. When i=N in step S225, the signal processing device 1 ends the analysis object data generation step S2.

As described above, according to the procedures in FIGS. 28 and 29, template data having a larger number of samples than the time-series data of the physical quantity detected by the L-th sensor is obtained by spline interpolation. Similarly, first to N-th analysis object data having a larger number of samples than the time-series data of the physical quantity detected by the first to N-th sensors are obtained by spline interpolation. Therefore, the signal processing device 1 can perform synchronous addition with higher resolution based on the template data and the first to N-th analysis object data.

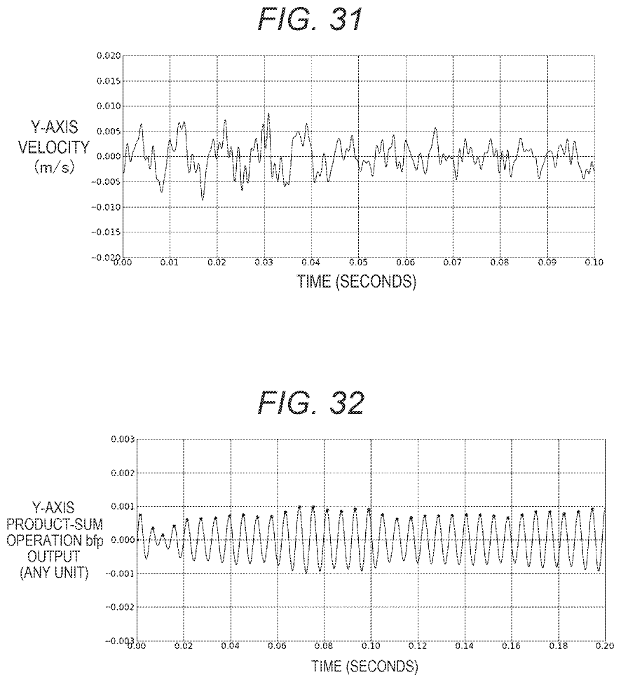

FIG. 30 is an enlarged view of a range of 0 seconds to 0.1 seconds of time-series data of a y-axis velocity detected by a y-axis speed sensor that is a second sensor. FIG. 31 is an enlarged view of a range of 0 seconds to 0.1 seconds of time-series data obtained by performing spline interpolation on the time-series data shown in FIG. 30. Comparing FIG. 30 with FIG. 31, it can be seen that smooth time-series data with improved time resolution can be obtained by spline interpolation.

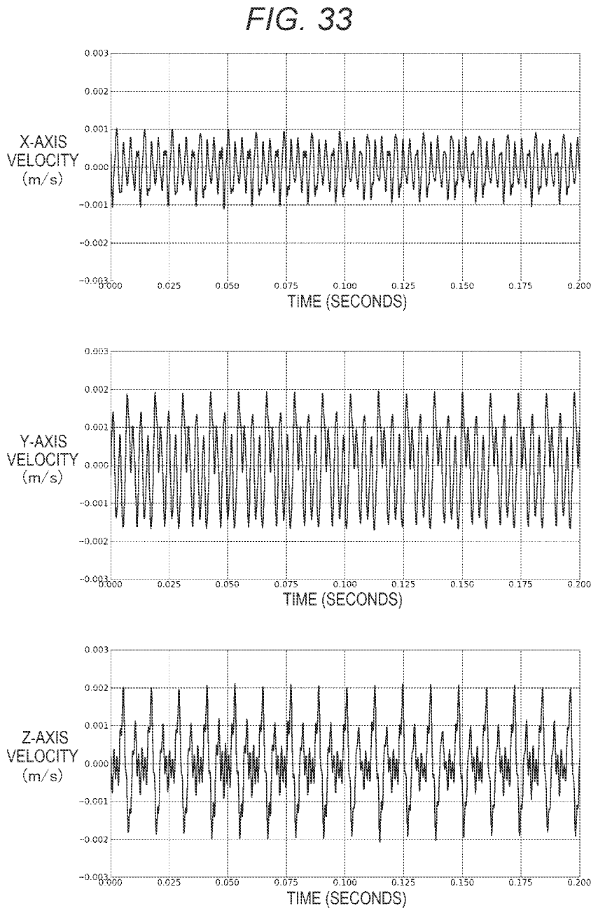

FIG. 32 is a graph showing time-series data obtained by performing band-pass filter processing on product-sum operation data, which is generated based on the time-series data shown in FIG. 31, with a passband of 150 Hz to 220 Hz. In the time-series data shown in FIG. 32, a signal component of 168.0 Hz to be analyzed is emphasized, and for example, time-points of respective local maximum points of the signal component of 168.0 Hz are detected with high accuracy as first to K-th synchronous timings. In FIG. 32, each local maximum point of the signal component of 168.0 Hz is indicated by a black point.

FIG. 33 is a graph showing first to third synchronously-added data obtained by performing synchronous addition on the first to third analysis object data. The first to third synchronously-added data shown in FIG. 33 is time-series data obtained by using, as the first to K-th synchronous timings, the time-points of the respective local maximum points of the signal component of 168.0 Hz to be analyzed included in the time-series data shown in FIG. 32. In FIG. 33, data of an upper section is the first synchronously-added data, data of a middle section is the second synchronously-added data, and data of a lower section is the third synchronously-added data. That is, the first synchronously-added data is time-series data obtained by performing synchronous addition on the time-series data of the x-axis velocity that is the first analysis object data. The second synchronously-added data is time-series data obtained by performing synchronous addition on the time-series data of the y-axis velocity that is the second analysis object data. The third synchronously-added data is time-series data obtained by performing synchronous addition on the time-series data of the z-axis velocity that is the third analysis object data. In the first to third synchronously-added data shown in FIG. 33, a signal component synchronizing with the signal component of 168.0 Hz to be analyzed is extracted. In particular, although the signal component synchronizing with the signal component of 168.0 Hz in the first analysis object data is smaller than that in the second analysis object data, the first synchronously-added data in which the signal component synchronizing with the signal component of 168.0 Hz is extracted with high accuracy is obtained.

Since a configuration example of the signal processing device 1 according to the sixth embodiment is the same as that in FIG. 22, illustration thereof is omitted. The template data generation circuit 11 generates template data based on time-series data obtained by performing spline interpolation on time-series data cut out from time-series data of a physical quantity detected by an L-th sensor. The analysis object data generation circuit 12 generates, for each integer i of 1 or more and N or less, i-th analysis object data based on time-series data obtained by performing spline interpolation on time-series data cut out from time-series data of the physical quantity detected by an i-th sensor. Other configurations and functions of the signal processing device 1 according to the sixth embodiment are the same as any of those of the first to fifth embodiments, and thus description thereof will be omitted.

As described above, in the signal processing method of the sixth embodiment, the template data having a larger number of samples than the time-series data of the physical quantity detected by the L-th sensor 21-L is obtained by spline interpolation. In addition, the first to N-th analysis object data having a larger number of samples than the time-series data of the physical quantity detected by the first to N-th sensors 21-1 to 21-N are obtained by spline interpolation. Thus, according to the signal processing method of the sixth embodiment, the signal processing device 1 can perform synchronous addition with higher resolution based on the template data and the first to N-th analysis object data.

### 7. Seventh Embodiment

Hereinafter, regarding a seventh embodiment, the same components as any of those in the first to sixth embodiments are denoted by the same reference signs, descriptions overlapping with those of the first to sixth embodiments are omitted or simplified, and contents different from those of the first to sixth embodiments will be mainly described.

Since a procedure of a signal processing method according to the seventh embodiment is the same as that in FIG. 1, FIG. 18, or FIG. 25, illustration thereof is omitted. In the signal processing method according to the seventh embodiment, the processing and procedure of the synchronous-timing detection step S4 are different from those of the first to sixth embodiments.

In the seventh embodiment, in the synchronous-timing detection step S4, the signal processing device 1 detects a synchronous timing, which is a timing synchronizing with a signal component to be analyzed, based on data obtained by performing spline interpolation on product-sum operation data.

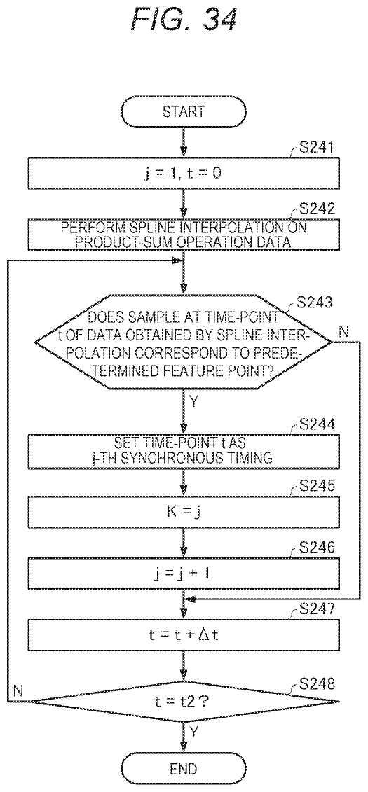

FIG. 34 is a flowchart showing an example of the procedure of the synchronous-timing detection step S4 in the seventh embodiment.

As shown in FIG. 34, first, the signal processing device 1 sets j=1 and t=0 in step S241, and performs spline interpolation on the product-sum operation data generated in the procedure in FIG. 4 in step S242.

Next, in step S243, the signal processing device 1 determines whether a sample at the time-point t of data obtained by performing spline interpolation on the product-sum operation data in step S242 corresponds to a predetermined feature point. The feature point may be a local maximum point, a zero-cross point, a local minimum point, or the like.

When it is determined in step S243 that the sample at the time-point t corresponds to the predetermined feature point, the signal processing device 1 sets the time-point t as a j-th synchronous timing in step S244.

Next, the signal processing device 1 sets K=j in step S245, sets j=j+1 in step S246, and sets t=t+Δt in step S247. When it is determined in step S243 that the sample at the time-point t does not correspond to the predetermined feature point, the signal processing device 1 does not perform steps S244, S245, and S246.

The signal processing device 1 repeats steps S242 to S247 until t=t2 in step S248, and when t=t2 in step S248, ends the synchronous-timing detection step S4.

As described above, according to the procedure in FIG. 34, time-series data having a larger number of samples than the product-sum operation data is obtained by spline interpolation. Therefore, the signal processing device 1 can perform synchronous addition with higher resolution based on the time-series data.

Since a configuration example of the signal processing device 1 according to the seventh embodiment is the same as that in FIG. 22, illustration thereof is omitted. The synchronous-timing detection circuit 14 detects a synchronous timing, which is a timing synchronizing with a signal component to be analyzed, based on data obtained by performing spline interpolation on product-sum operation data. Other configurations and functions of the signal processing device 1 according to the seventh embodiment are the same as any of those of the first to sixth embodiments, and thus a description thereof will be omitted.

As described above, according to the signal processing method of the seventh embodiment, the time-series data having a larger number of samples than the product-sum operation data obtained by is spline interpolation. Accordingly, the signal processing device 1 can perform synchronous addition with higher resolution based on the time-series data.

### 8. Eighth Embodiment

Hereinafter, regarding an eighth embodiment, the same components as any of those in the first to seventh embodiments are denoted by the same reference signs, descriptions overlapping with those of the first to seventh embodiments are omitted or simplified, and contents different from those of the first to seventh embodiments will be mainly described.

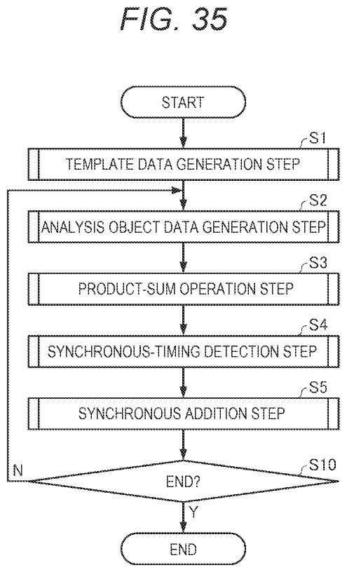

FIG. 35 is a flowchart showing a procedure of a signal processing method according to the eighth embodiment. As shown in FIG. 35, the signal processing method according to the eighth embodiment includes the template data generation step S1, the analysis object data generation step S2, the product-sum operation step S3, the synchronous-timing detection step S4, and the synchronous addition step S5. The signal processing method according to the embodiment is performed by, for example, the signal processing device 1 illustrated in FIG. 22.

As shown in FIG. 35, first, the signal processing device 1 performs the template data generation step S1, the analysis object data generation step S2, the product-sum operation step S3, the synchronous-timing detection step S4, and the synchronous addition step S5 as in the fourth embodiment.

The signal processing device 1 repeats steps S2 to S5 until the signal processing is ended in step S10.

As described above, in the embodiment, first to N-th analysis object data are updated until the signal processing ends, but the template data is not updated. When the template data is not updated and a cycle of a signal component to be analyzed included in the first to N-th analysis object data is changed due to a temporal change of a state of an object, first to N-th synchronously-added data are also changed. Therefore, for example, the signal processing device 1 can determine whether the state of the object changes with time based on a change in the first to N-th synchronously-added data.

In FIG. 35, the order of the template data generation step S1 and the analysis object data generation step S2 may be reversed. That is, the signal processing device 1 may perform the template data generation step S1 after performing the analysis object data generation step S2. The signal processing device 1 may perform the product-sum operation step S3 using template data generated in advance. That is, in FIG. 35, the template data generation step S1 may be omitted.

Since a configuration example of the signal processing device 1 according to the eighth embodiment is the same as that in FIG. 22, illustration and description thereof are omitted.

According to the signal processing method of the eighth embodiment described above, the template data is not updated. Therefore, when the cycle or intensity of the signal component to be analyzed included in the first to N-th analysis object data changes due to the temporal change of the state of the object, the intensity of the signal component included in the product-sum operation data changes. As a result, the intensity of the signal component included in the first to N-th synchronously-added data also changes. Thus, according to the signal processing method of the eighth embodiment, it is possible to make it easy to grasp the temporal change of the state of the object, a cause thereof, and the like.

### 9. Modification

In the embodiments described above, the template data is time-series data obtained by multiplying data cut out from time-series data of a physical quantity detected by an L-th sensor by a window function. Alternatively, the template data may be the data cut out from the time-series data of the physical quantity detected by the L-th sensor.

An update frequency of the template data and an update frequency of the first to N-th analysis object data are the same in the first to seventh embodiments, and may be different from each other. The update frequency of the template data may be lower than the update frequency of the first to N-th analysis object data. For example, the update frequency of the template data may be 1/P of the update frequency of the first to N-th analysis object data, P being an integer of 2 or more.

The signal processing device 1 generates the template data in the above-described embodiments. Alternatively, a device different from the signal processing device 1 may generate the template data and write the template data in the storage circuit 40 of the signal processing device 1.

Further, in the above-described embodiments, the time-series data of the physical quantity detected by the L-th sensor, which is any of the first to N-th sensors, is used in common for generation of the template data and generation of the L-th analysis object data. Alternatively, the template data may be generated using the time-series data of the physical quantity detected by an (N+1)-th sensor that is different from the first to N-th sensors.

The embodiments and modifications described above are examples, and the present disclosure is not limited thereto. For example, the embodiments and the modifications may be combined as appropriate.

The present disclosure includes substantially the same configurations (such as a configuration having the same function, method, and result and a configuration having the same object and effect) as the configurations described in the embodiments. The present disclosure includes a configuration in which a non-essential portion of the configuration described in the embodiments is replaced. The present disclosure includes a configuration capable of achieving the same operation and effect or a configuration capable of achieving the same object as the configuration described in the embodiments. The present disclosure includes a configuration obtained by adding a known technique to the configuration described in the embodiments.

The following contents are derived from the embodiments and modifications described above.

A signal processing method according to an aspect includes:
an analysis object data generation step of generating, for each integer i of 1 or more and N or less, i-th analysis object data based on time-series data of a physical quantity detected by an i-th sensor provided in an object to be analyzed to generate first to N-th analysis object data, N being a predetermined integer of 1 or more;
a product-sum operation step of generating product-sum operation data by performing a plurality of times of product-sum operation processing on template data and M-th analysis object data while shifting a phase of at least one of the template data and the M-th analysis object data, M being an integer of 1 or more and N or less, and the template data being time-series data including a signal component to be analyzed; and
a synchronous-timing detection step of detecting a synchronous timing, which is a timing synchronizing with the signal component to be analyzed, with respect to the first to N-th analysis object data based on the product-sum operation data, in which
the template data is shorter than the M-th analysis object data, and
a sampling rate of the M-th analysis object data is equal to a sampling rate of the template data.

In the signal processing method, since a signal component synchronizing with the signal component to be analyzed included in common in the template data and the M-th analysis object data is strengthened by product-sum operation processing, even when an intensity of the signal component to be analyzed is relatively low, product-sum operation data in which the signal component is extracted can be obtained. Since the sampling rate of the M-th analysis object data is equal to the sampling rate of the template data, orthogonality of each of the signal components having different frequencies is secured in the product-sum operation processing, and the signal component synchronizing with the signal component to be analyzed is correctly extracted. Since the product-sum operation processing is not operation processing in a frequency domain but operation processing in a time domain, even if the signal component to be analyzed contains jitter or does not have a constant cycle, the product-sum operation data in which the signal component is extracted can be obtained. Thus, according to the signal processing method, the timing synchronizing with the signal component to be analyzed included in the product-sum operation data can be accurately detected.

In the signal processing method according to an aspect,
in the synchronous-timing detection step, the synchronous timing may be detected based on a feature point of the product-sum operation data.

According to the signal processing method, since the feature point of the product-sum operation data is clear, the timing synchronizing with the signal component to be analyzed can be accurately detected based on the feature point.

In the signal processing method according to an aspect,
in the synchronous-timing detection step, the synchronous timing may be detected based on a feature point of time-series data obtained by performing filter processing on the product-sum operation data.

According to the signal processing method, since the signal component to be analyzed included in the product-sum operation data is emphasized by the filter processing, the timing synchronizing with the signal component to be analyzed can be accurately detected based on the product-sum operation data.

The signal processing method according to an aspect may include:
a synchronous addition step of performing, for each integer i, synchronous addition on the i-th analysis object data based on the synchronous timing to generate i-th synchronously-added data.

According to the signal processing method, by the synchronous addition based on the timing synchronizing with the signal component to be analyzed, the signal component synchronizing with the signal component to be analyzed is amplified, and a signal component not synchronizing with the signal component to be analyzed and a noise component are attenuated, and thus the signal component synchronizing with the signal component to be analyzed is extracted with high accuracy. In addition, since the synchronous addition can be performed based on the timing synchronizing with the signal component to be analyzed, a rotation pulse signal is not required, and the synchronous addition is not required assuming that a state of the object is any state.

In the signal processing method according to an aspect,
for each integer i, at least one of the template data and the i-th analysis object data may be data in which a signal component unnecessary for the analysis is reduced.

According to the signal processing method, an unnecessary signal component is reduced before the synchronous addition, and thus the signal component to be analyzed is correctly extracted by a relatively small number of times of the synchronous addition. Further, according to the signal processing method, for example, when a DC signal component that is not an object to be analyzed is reduced before the product-sum operation processing, the maximum value of the product-sum operation data is reduced, and it is possible to reduce the data amount of the product-sum operation data or the first to N-th synchronously-added data.

In the signal processing method according to an aspect,
in the product-sum operation step after the synchronous addition step, the product-sum operation data may be generated by using, as the template data, time-series data that is based on L-th synchronously-added data, L being any integer of 1 or more and N or less.

According to the signal processing method, since the signal component synchronizing with the signal component to be analyzed is extracted with high accuracy by the synchronous addition, the timing synchronizing with the signal component to be analyzed can be detected with high accuracy by performing the product-sum operation processing using the template data that is based on the time-series data obtained by the synchronous addition.

In the signal processing method according to an aspect,
the template data may be updated.

According to the signal processing method, the product-sum operation data including the signal component to be analyzed is obtained even when a cycle of the signal component changes due to a temporal change of a state of the object, and thus the timing synchronizing with the signal component can be detected based on the product-sum operation data. In addition, as an update interval of the template data is shorter, a decrease in detection accuracy of the synchronous timing due to the temporal change in the state of the object is reduced.

In the signal processing method according to an aspect,
the template data may not be updated.

According to the signal processing method, when the cycle or intensity of the signal component to be analyzed changes due to the temporal change of the state of the object, the intensity of the signal component included in the product-sum operation data changes, and thus the temporal change of the state of the object, a cause thereof, and the like can be easily grasped.

In the signal processing method according to an aspect,
the product-sum operation processing may be FIR filter processing on the M-th analysis object data, and
a coefficient of the FIR filter processing may be defined based on the template data.

According to the signal processing method, since the FIR filter processing is often included in a library of a system as a standard, the product-sum operation processing can be easily implemented.

In the signal processing method according to an aspect,
the integer N may be 2 or more.

According to the signal processing method, it is possible to accurately detect the timing synchronizing with the signal component to be analyzed, by setting, as the M-th analysis object data, data having the highest intensity of the signal component to be analyzed among the first to N-th analysis object data. Accordingly, even for other analysis object data in which the intensity of the signal component to be analyzed is lower than that of the M-th analysis object data, time-series data in which the signal component to be analyzed is extracted by the synchronous addition is obtained.

The signal processing method according to an aspect may include:
a template data generation step of generating the template data based on time-series data obtained by performing spline interpolation on time-series data cut out from time-series data of the physical quantity detected by an L-th sensor, L being any integer of 1 or more and N or less, in which
in the analysis object data generation step, for each integer i, the i-th analysis object data may be generated based on time-series data obtained by performing spline interpolation on time-series data cut out from time-series data of the physical quantity detected by the i-th sensor.

In the signal processing method, template data having a larger number of samples than the time-series data of the physical quantity detected by the L-th sensor is obtained by spline interpolation. Further, by spline interpolation, first to N-th analysis object data having a larger number of samples than the time-series data of the physical quantity detected by the first to N-th sensors are obtained. Thus, according to the signal processing method, it is possible to perform synchronous addition with higher resolution based on the template data and the first to N-th analysis object data.

In the signal processing method according to an aspect,
in the synchronous-timing detection step, the synchronous timing may be detected based on data obtained by performing spline interpolation on the product-sum operation data.

According to the signal processing method, since time-series data having a larger number of samples than the product-sum operation data is obtained by spline interpolation, synchronous addition can be performed with higher resolution based on the time-series data.

A signal processing device according to an aspect includes:
an analysis object data generation circuit configured to generate, for each integer i of 1 or more and N or less, i-th analysis object data based on time-series data of a physical quantity detected by an i-th sensor provided in an object to be analyzed to generate first to N-th analysis object data, N being a predetermined integer of 1 or more;
a product-sum operation circuit configured to generate product-sum operation data by performing a plurality of times of product-sum operation processing on template data and M-th analysis object data while shifting a phase of at least one of the template data and the M-th analysis object data, M being an integer of 1 or more and N or less, and the template data being time-series data including a signal component to be analyzed; and
a synchronous-timing detection circuit configured to detect a synchronous timing, which is a timing synchronizing with the signal component to be analyzed, with respect to the first to N-th analysis object data based on the product-sum operation data, in which
the template data is shorter than the M-th analysis object data, and
a sampling rate of the M-th analysis object data is equal to a sampling rate of the template data.

In the signal processing device, since a signal component synchronizing with the signal component to be analyzed included in common in the template data and the M-th analysis object data is strengthened by product-sum operation processing, even when an intensity of the signal component to be analyzed is relatively low, product-sum operation data in which the signal component is extracted can be obtained. Since the sampling rate of the M-th analysis object data is equal to the sampling rate of the template data, orthogonality of each of the signal components having different frequencies is secured in the product-sum operation processing, and the signal component synchronizing with the signal component to be analyzed is correctly extracted. Since the product-sum operation processing is not operation processing in a frequency domain but operation processing in a time domain, even if the signal component to be analyzed contains jitter or does not have a constant cycle, the product-sum operation data in which the signal component is extracted can be obtained. Thus, according to the signal processing device, the timing synchronizing with the signal component to be analyzed included in the product-sum operation data can be accurately detected.

What is claimed is:

1. A signal processing method comprising:
an analysis object data generation step of generating, for each integer i of 1 or more and N or less, i-th analysis object data based on time-series data of a physical quantity detected by an i-th sensor provided in an object to be analyzed to generate first to N-th analysis object data, N being a predetermined integer of 1 or more;
a product-sum operation step of generating product-sum operation data by performing a plurality of times of product-sum operation processing on template data and M-th analysis object data while shifting a phase of at least one of the template data and the M-th analysis object data, M being an integer of 1 or more and N or less, and the template data being time-series data including a signal component to be analyzed; and
a synchronous-timing detection step of detecting a synchronous timing, which is a timing synchronizing with the signal component to be analyzed, with respect to the first to N-th analysis object data based on the product-sum operation data, wherein
the template data is shorter than the M-th analysis object data, and
a sampling rate of the M-th analysis object data is equal to a sampling rate of the template data.

2. The signal processing method according to claim 1, wherein
in the synchronous-timing detection step, the synchronous timing is detected based on a feature point of the product-sum operation data.

3. The signal processing method according to claim 1, wherein
in the synchronous-timing detection step, the synchronous timing is detected based on a feature point of time-series data obtained by performing filter processing on the product-sum operation data.

4. The signal processing method according to claim 1, further comprising:
a synchronous addition step of performing, for each integer i, synchronous addition on the i-th analysis object data based on the synchronous timing to generate i-th synchronously-added data.

5. The signal processing method according to claim 4, wherein
for each integer i, at least one of the template data and the i-th analysis object data is data in which a signal component unnecessary for the analysis is reduced.

6. The signal processing method according to claim 4, wherein
in the product-sum operation step after the synchronous addition step, the product-sum operation data is generated by using, as the template data, time-series data that is based on L-th synchronously-added data, L being any integer of 1 or more and N or less.

7. The signal processing method according to claim 1, wherein
the template data is updated.

8. The signal processing method according to claim 1, wherein
the template data is not updated.

9. The signal processing method according to claim 1, wherein
the product-sum operation processing is FIR filter processing on the M-th analysis object data, and
a coefficient of the FIR filter processing is defined based on the template data.

10. The signal processing method according to claim 4, wherein
the integer N is 2 or more.

11. The signal processing method according to claim 1, further comprising:
a template data generation step of generating the template data based on time-series data obtained by performing spline interpolation on time-series data cut out from time-series data of the physical quantity detected by an L-th sensor, L being any integer of 1 or more and N or less, wherein
in the analysis object data generation step, for each integer i, the i-th analysis object data is generated based on time-series data obtained by performing spline interpolation on time-series data cut out from time-series data of the physical quantity detected by the i-th sensor.

12. The signal processing method according to claim 1, wherein
in the synchronous-timing detection step, the synchronous timing is detected based on data obtained by performing spline interpolation on the product-sum operation data.

13. A signal processing device comprising:
an analysis object data generation circuit configured to generate, for each integer i of 1 or more and N or less, i-th analysis object data based on time-series data of a physical quantity detected by an i-th sensor provided in an object to be analyzed to generate first to N-th analysis object data, N being a predetermined integer of 1 or more;
a product-sum operation circuit configured to generate product-sum operation data by performing a plurality of times of product-sum operation processing on template data and M-th analysis object data while shifting a phase of at least one of the template data and the M-th analysis object data, M being an integer of 1 or more and N or less, and the template data being time-series data including a signal component to be analyzed; and
a synchronous-timing detection circuit configured to detect a synchronous timing, which is a timing synchronizing with the signal component to be analyzed, with respect to the first to N-th analysis object data based on the product-sum operation data, wherein
the template data is shorter than the M-th analysis object data, and
a sampling rate of the M-th analysis object data is equal to a sampling rate of the template data.
